(19) United States
(12) Patent Application Publication
(10) Pub. No.: US 2020/0388177 A1
(43) Pub. Date: Dec. 10, 2020

(54) SIMULATED REALITY BASED CONFIDENCE ASSESSMENT

(71) Applicant: Adept Reality, LLC, New York, NY (US)

(72) Inventors: Rodney Joseph Recker, Shelton, CT (US); David John Smith, Morristown, NJ (US); Lyron L. Bentovim, Demarest, NJ (US)

(21) Appl. No.: 16/894,031

(22) Filed: Jun. 5, 2020

Related U.S. Application Data
(60) Provisional application No. 62/858,170, filed on Jun. 6, 2019.

(51) Int. Cl. G09B 5/12; G06T 19/00; G06F 3/01

(52) U.S. Cl. CPC G09B 5/12; G06F 3/017; G06F 3/011; G06T 19/006

(57) ABSTRACT

Disclosed is a system for assessing user interaction with a simulated reality environment. The system includes a user device, sensor(s), a computer readable instructions, and a processor. The sensor(s) detect user data associated a simulated real world task in the simulated reality environment related to at least one of biological indicator, user interactional input, and behavioral user activity. The processor is configured to cause display, on the user device, of the simulated reality environment configured for user interaction with the simulated real world task; receive, from the sensor(s), data related to the detected user data associated with the simulated real world task; determine, based on the received user data, a confidence grade for the user. The confidence grade is indicative of the user's confidence in performance of the simulated real world task within the simulated reality environment. The processor causes transmission of feedback related to the confidence grade.

### CROSS-REFERENCE TO RELATED APPLICATION

This application claims priority to U.S. Provisional Application No. 62/858,170, filed on Jun. 6, 2019, the disclosure of which is incorporated by reference herein in its entirety.

### TECHNICAL FIELD

The present invention relates to systems and methods for simulated reality based task assessment.

### BACKGROUND

A simulated reality experience provides a three-dimensional (3D) representation of a real or simulated world. Simulated reality encompasses both augmented reality and virtual reality. In an augmented reality experience, a user device receives live image content of a real world environment, and an augmented reality image object is overlaid on the real world environment for display. In a virtual reality experience, a user device receives virtual reality image content of a virtual reality environment, and virtual reality image objects are overlaid on the virtual reality environment for display.

Simulated reality environments are often interactive, allowing a user to interact with the surrounding environment and simulated reality objects. Some virtual reality systems are used for training. For example, a user may be virtually immersed in a dangerous situation (e.g., dealing with an office fire, handling hazardous materials, operating dangerous machinery, etc.) and may interact with the environment to figure out how to deal with the situation through trial and error. In this manner, the user may learn the consequences of certain actions in the simulated reality environment and apply the learned skills to the same real world scenario should it arise.

Current simulated reality systems provided limited feedback on a user's interaction with the simulated reality environment. At most, present virtual reality systems provide visual feedback to the user of the success or failure of task completion. For example, if a user successfully extinguishes a fire, the fire disappears; however, if the user fails to extinguish the fire, the fire spreads.

There is a need for a simulated reality system configured to monitor and assess user interaction with a simulated reality environment and to provide more comprehensive feedback.

The information included in this Background section of the specification, including any references cited herein and any description or discussion thereof, is included for technical reference purposes only and is not to be regarded subject matter by which the scope of the invention as defined in the claims is to be bound.

### SUMMARY

Disclosed is a system for assessing user interaction with a simulated reality environment. A system is provided for evaluating a user confidence grade relative to a task in a simulated reality environment. The system includes a user device configured to display simulated reality to a user. The system includes at least one sensor for monitoring detected user data associated a simulated real world task in the simulated reality environment, the user data comprising data related to at least one of biological indicators, user interactional input, and behavioral user activity. The system includes a non-transitory memory containing computer readable instructions and a processor configured to process the instructions. The instructions when executed to cause the processor to: cause display, on the user device, of the simulated reality environment configured for user interaction with the simulated real world task; receive, from the at least one sensor, data related to the detected user data associated with the simulated real world task; determine, based on the received detected user data, a confidence grade for the user, wherein the confidence grade is indicative of the user's confidence in performance of the simulated real world task within the simulated reality environment; and cause transmission of feedback related to the confidence grade.

The confidence grade may be related to a probability that the user engages in guessing in performing the simulated real world task.

The simulated real world task may include one of a virtual task, a mixed reality task or an augmented reality task. The confidence grade may be independent on the user's ability to perform the virtual, mixed or augmented reality task.

The user interactional input may include information related to the user's physical motion used to interact with the simulated reality environment.

The display of the simulated reality environment includes displaying instructions, on the user device, detailing the real world task requirements.

In the system, the at least one sensor detects user hand motion associated with the simulated real world task in the simulated reality environment. The instructions when executed further cause the processor to assess the user's confidence in the placement of the hands thereby contributing to the assessment of the confidence grade.

The confidence grade includes contribution from a user response time that is based on a determined amount of time it takes the user to engage in accurate hand motion.

The user behavioral activity may include information related to a user's eye glance directions.

The user's eye glance directions may be translated into the user's confidence in understanding the task represented in the simulated reality environment contributing to the confidence grade.

The biological indicators may be related to at least one of heart rate, breathing pattern, and blood pressure.

The user's biological indicators may be translated into the user's confidence in understanding the task represented in the simulated reality environment contributing to the confidence grade.

The confidence grade may be determined by comparing the received user detected data to benchmark data stored in a database.

The benchmark data has an associated benchmark confidence grade.

The instructions when executed further cause the processor to provide an additional task, analysis, or training in the simulated reality environment in response to receiving a particular confidence grade.

The instructions when executed further cause the processor to store the confidence grade data for comparison to future users and establishing their confidence grade.

The instructions when executed to cause the processor to receive further includes instructions which when executed causes the processor to receive at least two of the interactional input, the biological indicators, or the behavioral activity as the detected user data.

This Summary is provided to introduce a selection of concepts in a simplified form that are further described below in the Specification. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a diagram of a system for simulated reality based task assessment according to an embodiment;

FIG. 2 is a simplified block diagram of a computing device that may be used with the system of FIG. 1;

FIG. 3 is a flow chart illustrating a method for assessing user interaction with a simulated reality environment, which may be performed by the system of FIG. 1;

FIG. 4 is a flow chart illustrating a method for assessing trends in user performance over time, which may be performed by the system of FIG. 1;

FIG. 5 is an illustration of a simulated reality scenario presented by the system of FIG. 1;

FIG. 6 is a block diagram of a simulated reality based task assessment server system;

FIG. 7 is a block diagram of a simulated task run for the system of FIG. 1;

FIG. 8 is a block diagram of a task;

FIG. 9A is a block diagram of the sensors of the user monitoring subassembly of FIG. 6;

FIG. 9B is a block diagram of the biofeedback sensor(s) of FIG. 9A;

FIG. 9C is a block diagram of the artificial intelligence (IA) sensor(s) of FIG. 9A;

FIG. 10 is a block diagram of task execution metrics;

FIG. 11 is a block diagram of benchmark task data elements of the benchmark data;

FIG. 12 is a block diagram of a benchmark user data point and overall benchmark task execution grade;

FIG. 13 is a block diagram of benchmark user data points for use in determining an overall benchmark task execution grade associated with biological indicators;

FIG. 14 is a block diagram of a task execution grading module to determine a task execution grade;

FIG. 15 is an example simulated reality scenario of a task or sub-task with a user observing the simulated reality scenario;

FIG. 16A is an example simulated reality scenario tracking a user's head direction relative to the simulated reality scenario of the task or sub-task of FIG. 15;

FIG. 16B is an example simulated reality scenario tracking a user's eye direction relative to the simulated reality scenario of the task or sub-task of FIG. 15;

FIG. 17 is an example simulated reality scenario tracking a user's interactional input to the simulated reality scenario of the task or sub-task of FIG. 15 using a controller;

FIG. 18 is an example simulated reality scenario tracking a user's interactional input to the simulated reality scenario of the task or sub-task of FIG. 15 using mixed reality and/or eye tracking;

FIG. 19 is a flow chart illustrating a task grading method for a task or sub-task during a simulation task run representative of the simulated reality scenario; and

FIG. 20 is a flow chart illustrating a guessing method for uses in the task grading method of FIG. 19.

### DETAILED DESCRIPTION

In several embodiments herein, systems and methods for assessing user interaction with a simulated reality environment are disclosed. In several embodiments, a simulated reality environment is presented to a user, and the user's interaction with the simulated reality environment is monitored and analyzed. In several embodiments, the simulated reality environment presents a real world scenario to a user. The user may execute one or more tasks based on the real world scenario presented. As the user executes the one or more tasks, the user's responses and/or actions (e.g., biological, physiological, voluntary, involuntary, etc.) may be monitored. The user data collected may be analyzed to assess the user's interaction with the simulated reality environment as the user executes the one or more tasks and/or the user's ability to execute and/or complete the one or more tasks. For example, the collected data may be compared to benchmark data to assess the user's task performance. For example, the user's confidence in his or her actions (e.g., in interactions with the simulated reality environment) may be determined based on the collected data. For example, the likelihood the user was guessing versus applying prior knowledge to perform the task may be assessed as part of a confidence grade.

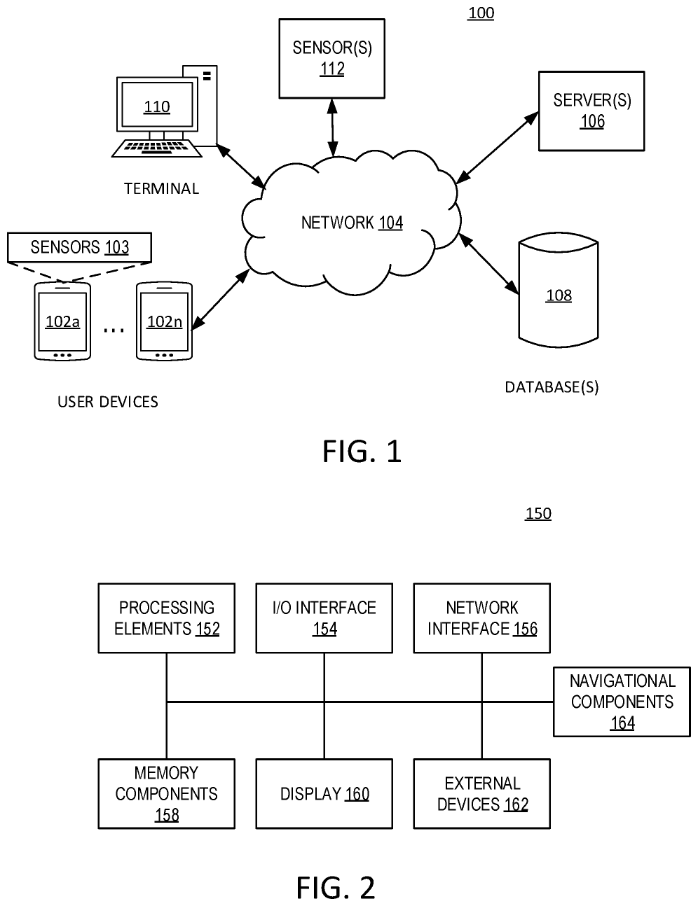

Turning to the figures, systems and methods for assessing user interaction with a simulated reality environment will now be discussed. FIG. 1 is a diagram of a simulated reality based task assessment system 100 for presenting a real world based scenario within a simulated reality environment on one or more user devices 102a-n, and for monitoring and assessing user interaction with the simulated reality environment. For example, the simulated reality based task assessment system 100 may be a simulated reality based confidence assessment system that assesses a user's confidence as the user interacts with the simulated reality environment. The user device(s) 102a-n can be any of various types of computing devices, e.g., smart phones, tablet computers, desktop computers, laptop computers, set top boxes, gaming devices, wearable devices, or the like. The user device(s) 102a-n provides output to and receives input from a user. For example, the user device(s) 102a-n may receive identifying information from a user and output simulated reality to a user. The simulated reality presentation can be displayed according to various suitable methods, for example, on a display screen of a user device 102a-n, or through a separate headset, focal lens, or other suitable device that is communicatively coupled to the user device 102a-n. The type and number of user devices 102a-n may vary as desired.

The user device(s) 102a-n may include a camera or sensor that captures image content. The captured image content can be two-dimensional or three-dimensional. The user device(s) 102a-n can communicate with one or more servers 106 via a network 104. The user device(s) 102a-n can communicate with the network 104, for example, by way of a wireless access point, a cellular cite, and/or by other suitable access points, such as BLUETOOTH, short-wavelength ultra-high frequency (UHF) radio waves or other connections.

The user device(s) 102a-n can have communication interfaces and/or sensors 103 for detecting data that is indicative of a condition attribute of the user device(s) 102a-n. For example, the user device(s) 102a-n can have a global positioning system (GPS) interface that communicates with a GPS satellite to receive information indicative of a geolocation of the user device(s) 102a-n. The sensors 103 of the user device(s) 102a-n may have a compass, magnetometer, or other sensor for detecting or determining the heading of the user device(s) 102a-n. The sensors 103 of the user device(s) 102a-n can have an accelerometer, e.g., comprising piezoelectric sensors, for detecting movement of the user device(s) 102a-n. The accelerometer can also indicate tilt of the user device(s) 102a-n, including its pitch, roll, and yaw and position and/or movement about its pitch, roll, and yaw axes. The sensors 103 of the user device(s) 102a-n can have a barometric pressure sensor or other sensors for detecting an altitude of the user device(s) 102a-n. The sensors 103 of the user device(s) 102a-n can have a wireless network communication interface and can be configured to detect the proximity of the user device(s) 102a-n to a wireless access point.

A managing terminal 110 can be communicatively coupled to the server(s) 106 and/or the database(s) 108 via network 104, for managing the system 100. For example, a manager of the system 100 can use terminal 110 to assign, modify, update, and/or confirm user data and/or benchmark data stored in the database(s) 108. Furthermore, one or more sensors 112 may be communicatively coupled to the server(s) 106, terminal 110 and/or the database(s) 108 via network 104.

The system 100 stores user data, benchmark data, and, in some embodiments, task execution metric data, for example, in one or more databases 108. The stored data can be uploaded to the database(s) 108 from one or more user devices 102a-n and/or sensors 112. The benchmark data can include benchmark user data and benchmark task execution values/grades, as discussed in more detail below. While FIG. 1 shows the database(s) 108 being a remote database (e.g., cloud-based database) communicatively coupled to the user device(s) 102a-n and server(s) 106 via network 104, in some embodiments, the database(s) 108 can be stored in a local memory of the user device(s) 102a-n and/or in a local memory of the server(s) 106.

A simplified block structure for a computing device 150 that may be used with the system 100 or integrated into one or more of the system 100 components is shown in FIG. 2. For example, the server 106, user device(s) 102a-n, sensor(s) 112, managing terminal 110 and/or database(s) 108 may include one or more of the components shown in FIG. 2 and use one or more of these components to execute one or more of the operations disclosed in methods 200 and 250. With reference to FIG. 2, the computing device 150 may include one or more processing elements 152, an input/output interface 154, a network interface 156, one or more memory components 158, a display 160, and one or more external devices 162. Each of the various components may be in communication with one another through one or more busses, wireless means, or the like.

The one or more processing elements 152 may be substantially any electronic device capable of processing, receiving, and/or transmitting instructions. For example, the processing element(s) 152 may be a central processing unit, microprocessor, processor, or a microcomputer. Additionally, it should be noted that the processing element(s) 152 may include more than one processing member. For example, a first processing element 152 may control a first set of components of the computing device 150 and a second processing element 152 may control a second set of components of the computing device 150, where the first and second processing elements 152 may or may not be in communication with each other, e.g., a graphics processor and a central processing unit which may be used to execute instructions in parallel and/or sequentially.

The input/output interface 154 allows the computing device 150 to receive inputs from a user and provide output to the user. For example, the input/output interface 154 may include a capacitive touch screen, keyboard, mouse, camera, stylus, or the like. The type of devices that interact via the input/output interface 154 may be varied as desired. Additionally, the input/output interface 154 may be varied based on the type of computing device 150 used. Other computing devices 150 may include similar sensors and other input/output devices 154.

The memory components 158 are used by the computer 150 to store instructions for the processing element 152, as well as store data, such as user data, benchmark data, and, in some embodiments, task execution data, and the like. The memory components 158 may be, for example, non-volatile storage, a magnetic storage medium, optical storage medium, magneto-optical storage medium, read only memory, random access memory, erasable programmable memory, flash memory, or a combination of one or more types of memory components 158.

The display 160 may be separate from or integrated with the computing device 150. For example, for cases in which the computing device 150 is a smart phone or tablet computer, the display 160 may be integrated with the computing device 150 and in instances where the computing device 150 is a server or a desktop computer the display 160 may be separate from the computing device 150. The display 160 provides a visual output for the computing device 150 and may output one or more graphical user interfaces (GUIs). The display may be a liquid display screen, plasma screen, light emitting diode screen, cathode ray tube display, and so on. The display 160 may also function as an input device in addition to displaying output from the computing device 150 to enable a user to control, manipulate, and calibrate various components of the computing device 150. For example, the display 160 may include capacitive touch sensors, infrared touch sensors, resistive grid, or the like that may capture a user's input to the display 160.

The network interface 156 receives and transmits data to and from the computing device 150. The network interface 156 may transmit and send data to the network 104, other computing devices, or the like. For example, the network interface 156 may transmit data to and from other computing devices through the network 104 which may be a wireless network (Wi-Fi, BLUETOOTH, cellular network, etc.) or a wired network (Ethernet), or a combination thereof. In particular, the network 104 may be substantially any type of communication pathway between two or more computing devices. For example, the network interface 156 may include components that are wireless, wired (e.g., USB cable), or a combination thereof. Some examples of the network 104 include cellular data, Wi-Fi, Ethernet, Internet, BLUETOOTH, closed-loop network, and so on. The type of network 104 may include combinations of networking types and may be varied as desired.

The external devices 162 are one or more devices that can be used to provide various inputs to the computing device 150, e.g., a mouse, microphone, keyboard, trackpad, or the like. The external devices 162 may be local or remote and may vary as desired. The navigational components 164 of the computing device may include a global positioning system (GPS) interface, accelerometer, gyroscope, and magnetometer. For example, the navigational components 164 may include inertial measurement units.

The network 104 may be substantially any type or combination of types of communication systems for transmitting data either through a wired or wireless mechanism (e.g., Wi-Fi, Ethernet, BLUETOOTH, cellular data, or the like). In some embodiments, certain components in the system 100 may communicate via a first mode (e.g., BLUETOOTH) and others may communicate via a second mode (e.g., Wi-Fi). Additionally, certain components may have multiple transmission mechanisms and be configured to communicate data in two or more manners. The configuration of the network 104 and communication mechanisms for each of the components may be varied as desired.

The server(s) 106 includes one or more computing devices that process and execute information. The server(s) 106 may include its own processing elements, memory components, and the like, and/or may be in communication with one or more external components (e.g., separate memory storage) (an example of computing elements that may be included in the server(s) 106 is disclosed below with respect to FIG. 2). The server(s) 106 may also include one or more server computers that are interconnected together via the network 104 or separate communication protocol. The server(s) 106 may host and execute a number of the processes executed by the system 100. The server(s) 106 may be webservers running thereon webserver applications.

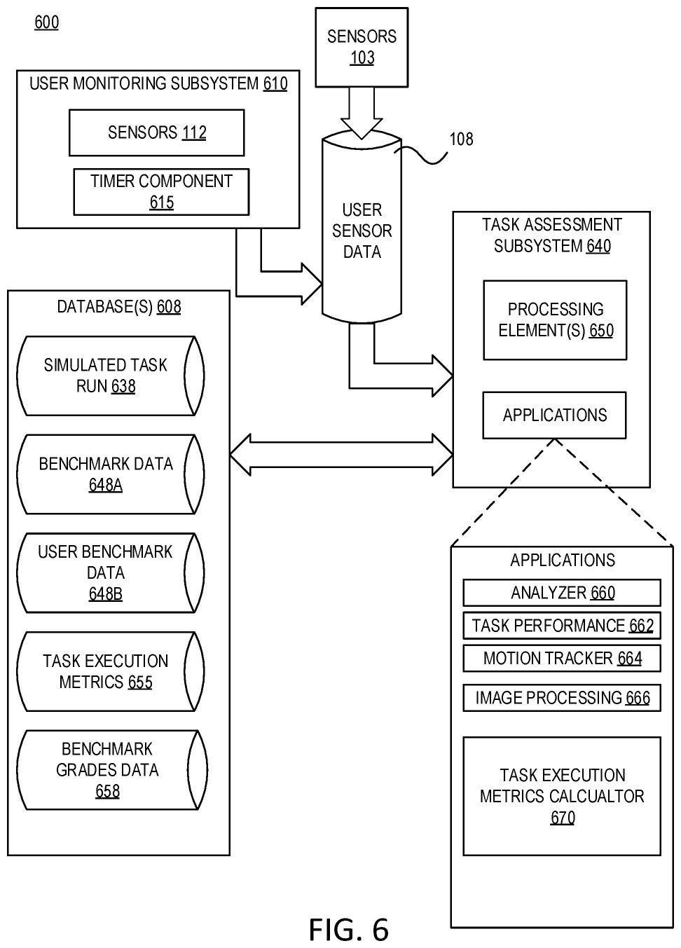

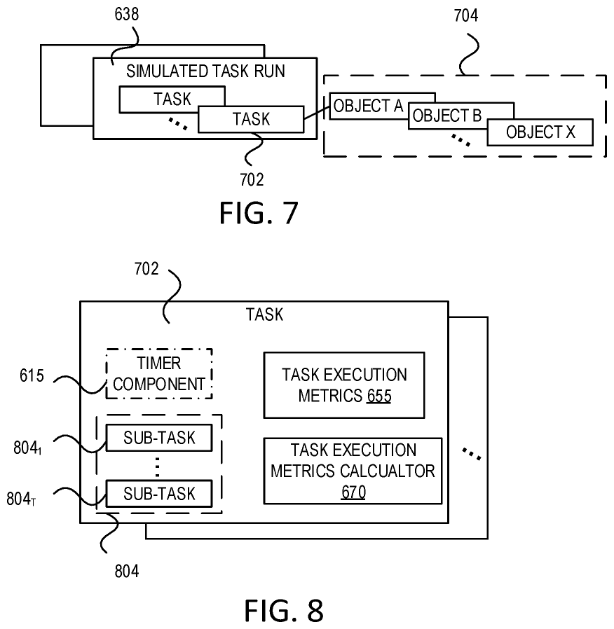

FIG. 6 is a block diagram of a simulated reality based task assessment server system 600 which may be formed by the server(s) 106, sensors 112 and database(s) 108. The simulated reality based task assessment server system 600 may be described in relation to FIGS. 7, 8 and 9A-9C. In many embodiments, a simulated reality based task assessment system 600 is provided that includes a user monitoring subsystem 610 and a task assessment subsystem 640. The simulated reality based task assessment system 600 may be a virtual reality system, an augmented reality system, or a mixed reality system. The user monitoring subsystem 610 may include one or more sensors 112 for monitoring one or more user responses and/or actions and, optionally, a database 108 for storing the user data collected by the one or more sensors 112 and/or sensors 103. The user monitoring subsystem 610 may include a timer component 615. One or more of the components of the user monitoring subsystem 610, including sensors, may be implemented using hardware, firmware, software or a combination of any of these. The components and sensors may be implemented as part of a microcontroller, processor, and/or graphics processing units.

The task assessment subsystem 640 may communicate with a database 608 for storing benchmark data 648A and may include a processing element 650 including instructions to analyze 660 the collected user data relative to the benchmark data 648A to determine the user's task performance 662 during a simulated task execution run 638. In some embodiments, the task assessment subsystem 640 may also determine task execution metrics 655 based on the collected user data and analyze the task execution metrics relative to the user data to further assess the user's task performance. The processing element 650 may be implemented using hardware, firmware, software or a combination of any of these. For instance, each processing element 650 may be configured to analyze the sensor data, determine task performance, motion tracking, image processing and task execution metrics calculations, for example. The processing element 650 may be implemented as part of a microcontroller, processor, and/or graphics processing units.

It is contemplated that the databases 108 coupled to the user monitoring subsystem 610 and the database(s) 608 coupled to the task assessment subsystem 640 may be a single database or different databases. The user benchmark data 648B includes the current user's measured data for the one or more simulation runs including the current run for which metrics are calculated. The database(s) 608 may include benchmark grades data 658.

Referring also to FIG. 7 a block diagram of a simulated task run 638 is shown. In several embodiments, one or more simulation runs 638 are executed for a current user. A simulation run 638 is the presentation of a simulated reality environment to a user on a display device (i.e., display 160). The simulated reality environment may include a simulated reality scenario including one or more tasks 702 to be executed by the current user. The one or more tasks 702 are real world tasks that may require use of one or more simulated reality objects 704. For example, a task 702 may require use of two or more objects 704 (denoted as object A, object B, . . . , object X) in a particular order (e.g., tool A must be used before tool B). The system may adapt or modify the task or sub-task based on the measured responses in real time. In other words, the sequence or order may be altered based on the level of expertise of the user or a past score of the user to make the task or sub-task more challenging.

FIG. 8 is a block diagram of a task 702. In several embodiments, a task 702 may include one or more sub-tasks 804. For example, a task 702 may be to operate a forklift. Operating a forklift may have several sub-tasks 804i . . . 804_{T} where T is a non-zero integer. The sub-tasks may require the user to apply and release parking brake, change gears, change directions, move, tilt and adjust width of fork, etc. A simulation run 638 may end when all of the sub-tasks of the task 702 are complete or when the user or an administrator ends the simulation task run 638. In several embodiments, a timer component 715 is run while the simulation task run 638 is executed to monitor time throughout the simulation run. Timer component 715 may be the same timer component 615. However, different timer components may run simultaneously and/or overlap.

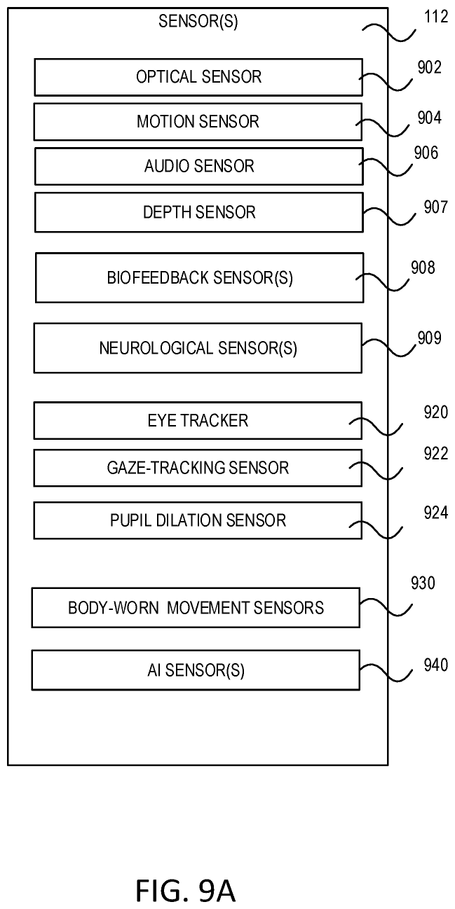

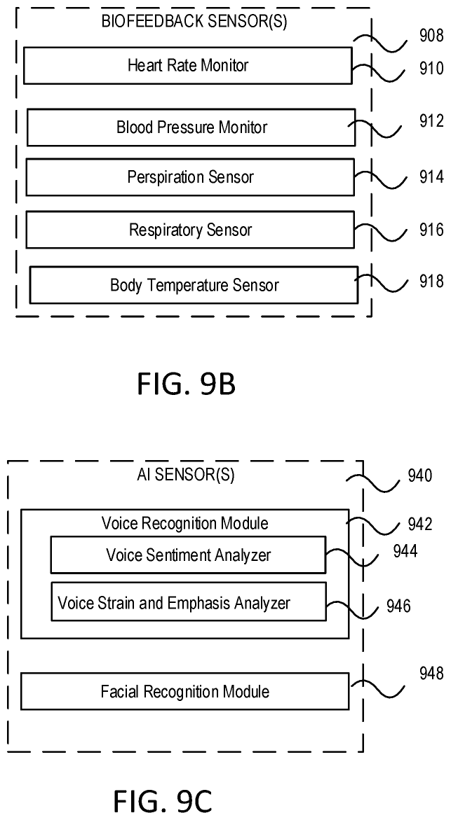

FIG. 9A is a block diagram of the sensors of the user monitoring sub-assembly of FIG. 6. FIG. 9B is a block diagram of the biofeedback sensor(s) 908 of FIG. 9A. FIG. 9C is a block diagram of the artificial intelligence (IA) sensor(s) 940 of FIG. 9A. The one or more sensors 112 of the user monitoring subsystem 610 may include any sensor for measuring user responses and/or actions. For example, a sensor of the user monitoring subsystem 610 may be an optical sensor (e.g., a camera) 902, motion sensor 904, eye tracker 920, biofeedback sensor(s) 908 such as a heart rate monitor 910 (FIG. 9B), blood pressure monitor (e.g., a sphygmomanometer) 912 (FIG. 9B), perspiration sensor (e.g., electrodes) 914 (FIG. 9B), respiratory sensor 916 (FIG. 9B), or artificial intelligence sensor(s) 940 such as voice recognition module 942 (FIG. 9C), facial recognition module 948 (FIG. 9C), and the like. The sensors 112 may include an audio sensor 906 such as a microphone interfaced with the voice recognition module 942. The microphone may pick-up the user's voice during the task.

For example, the sensors 112 may include a depth sensor 90 and a neurological sensor 909. The biofeedback sensor(s) 908 may include body temperature sensor 918. The motion sensor 904 may include a gyroscope. The voice recognition module 942 may include a sentiment analysis 944 API (e.g., connected to voice recognition) and a voice strain and emphasis analyzer 946.

The sensors 112 may include body-worn movement sensor(s) (e.g., worn by a user) 930, gaze-tracking sensor 922, pupil dilation sensor 924, and the like. The eye tracker 920, the gaze-tracking sensor 922, and pupil dilation sensor 924 may be used to determine the gaze direction of the user. There are known algorithms for eye gaze tracking. Eye gaze algorithms may detect and track the iris of the eye. Eye gaze algorithms may using pupil detection may include Starburst and circular Hough transform, by way of non-limiting examples.

In several embodiments, while a user interacts with a simulated reality environment during a simulation run, the one or more sensors 112 monitor one or more user responses and/or actions. For example, a user may have a task 702 (FIG. 7) to execute within the simulated reality environment. The task 702 (FIG. 7) may be any task (e.g., operate a forklift, build an engine, replace a clutch, selecting an answer in a multiple choice questionnaire, etc.). User responses and/or actions measured while the user executes the task 702 (FIG. 7) may include, for example, biological indicators, user interactional input, and behavioral user activity. For example, biological indicators detected by the biofeedback sensor(s) 908 may include biometrics or other indicators of biological functions. For example, biological indicators detected by the biofeedback sensor(s) 908 may include heart rate, blood pressure, body temperature, perspiration rate, respiratory rate, breathing patterns, and the like. As another example, user interactional input may include one or more actions indicative of user interaction with the simulated reality environment. For example, user interactional input may include body movement, such as, for example, movement or placement of the body as a whole (e.g., moving forward, backward, left, right, leaning, slouching, reaching, etc.) and/or of one or more body parts (e.g., hands, feet, head, etc.). For example, where the user reaches, towards what simulated reality object the user reaches, in what order the user reaches towards or grabs each simulated reality object, how the user is positioned (or repositions his or herself) relative to one or more simulated reality objects, what part of the simulated reality object the user grabs, and the like, may be measured. Various image processing techniques 666 (FIG. 6) may be performed on the captured image to assess user movement. For example, a sequence of captured images may indicate the user initially grabbed one object before reaching for the other object. As another example, a motion sensor 904 may supply data to a motion tracker 664 used to detect where a user moves and the speed of user movement. Feature extraction algorithms such as for motion tracking, object tracking, frame differencing and background subtraction are examples of algorithms for tracking motion using image data, such as in a raster format. Additionally, inertial measurement units (IMUs) that are body worn or hand-held may be used to determine six or nine degrees of freedom including pitch, roll, and yaw and x, y, z coordinate locations. The calculations performed by IMUs are well established in the art of motion tracking.

As another example, behavioral user activity may include secondary actions and/or responses, such as unintentional, undirected, or passive actions, involuntary movements, micro-movements, speech or expressions, neurological activity, or other user actions that can be measured as the user interacts with the simulated reality environment. For example, behavioral user activity may include behavior movements or patterns of movement that the user may not be immediately aware of or intended. For example, this could include eye movement, secondary or incidental body movement, speech patterns, facial expressions, and the like. For example, secondary body movement may include how the user is standing or sitting while performing the task (e.g., slouching, leaning, standing straight up, etc.), how the user holds his or her head, whether the user touches his or her face, whether the user squints, whether the user's mouth is open or closed, and any other incidental movement of the body that may correspond to confidence level (including the face and eyes).

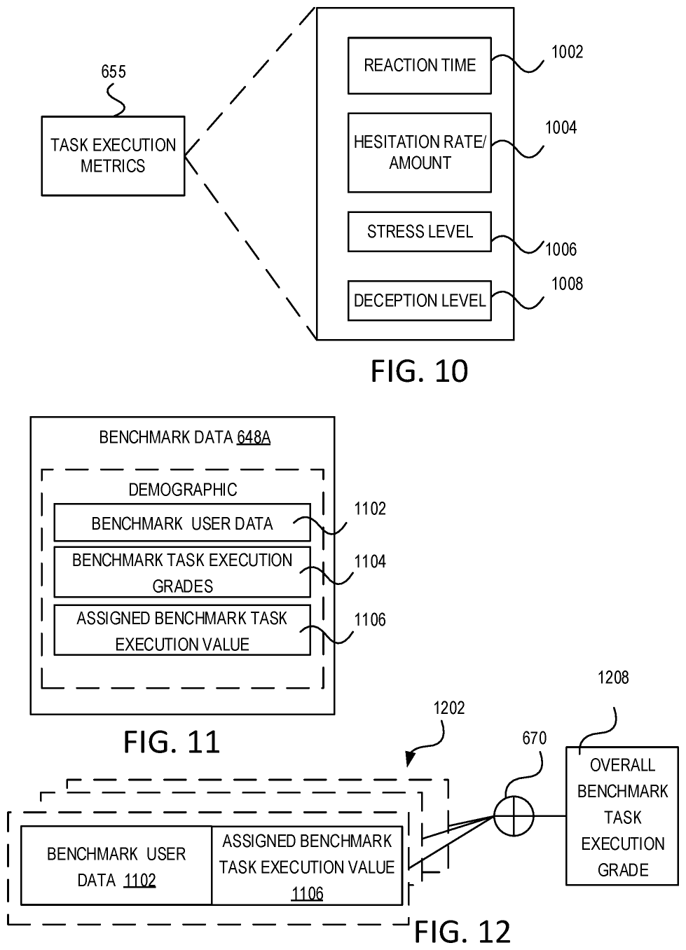

Referring also to FIG. 10, a block diagram of task execution metrics 655 is shown. In some embodiments, the task assessment subsystem 640 may determine one or more task execution metrics 655 based on the detected user data by a task execution metrics calculator 670. Each task 702 may have its own task execution metrics calculator 670. The one or more calculated task execution metrics 655 may be based on, for example, reaction time 1002, hesitation rate 1004 and/or amount, stress levels 1006, deception level (e.g., lying vs. truth) 1008, and the like. The deception level may include voice recognition, voice tone rise, voice tone lowering or other speech parameter to determine if the user is lying or telling the truth. The deception level may be based on a range of values with at least one value or range representative of a deception level of lying. A deception level of zero may represent truth or zero deception. A deception level range of truth may be a range from 0-5 out of 10, for example. The deception level may be based on eye and face movements and/or biological indicators.

For example, the user monitoring subsystem 610 may also include a timer component (e.g., a timer) 615 to monitor timing and duration of the one or more user responses and/or actions, as well as time in between different responses and/or actions or sub-tasks within the task. For example, a “START” graphic may flash in front of the user and a timer may simultaneously begin to measure the time it takes for the user to start the task (e.g., the time it takes for the user to grab an object, as measured by hand and body movement). In this example, the task execution subsystem 640 may analyze the hand and body movement data collected over the time data collected to determine the user's reaction time.

FIG. 11 is a block diagram of benchmark task data elements of the benchmark data 648A. The benchmark data 648A stored within the database 608 of the task assessment subsystem 640 may include benchmark user data 1102 associated with one or more benchmark task execution grades 1104. In some embodiments, the benchmark user data 1102 may be obtained from one or more benchmark users (e.g., different from the current user) performing the same task in the same simulated reality environment. The one or more benchmark users may have ordinary skill at executing the associated task. The benchmark data 648A may be organized by at least one user demographic data metric, such as age, sex, health status, etc. The one or more benchmark users may perform a benchmark simulation run in which the one or more benchmark users perform the same task (i.e., task 702) in the same simulated reality environment. As the one or more benchmark users execute the task, user data, such as that discussed above (e.g., including biological indicators, user interactional input, and behavioral user activity), is measured and stored as benchmark user data 1102 within the database of the task assessment subsystem 640. In some embodiments, the benchmark user data 1102 may be obtained from the current user. For example, as the current user executes one or more tasks during a simulation run, the data collected may be stored as benchmark data. For example, data collected during an initial simulation run may be stored as benchmark data. In some embodiments, the stored benchmark data (e.g., the stored benchmark user data and/or associated benchmark task execution grades) may be arbitrary values randomly established by the system or an administrator.

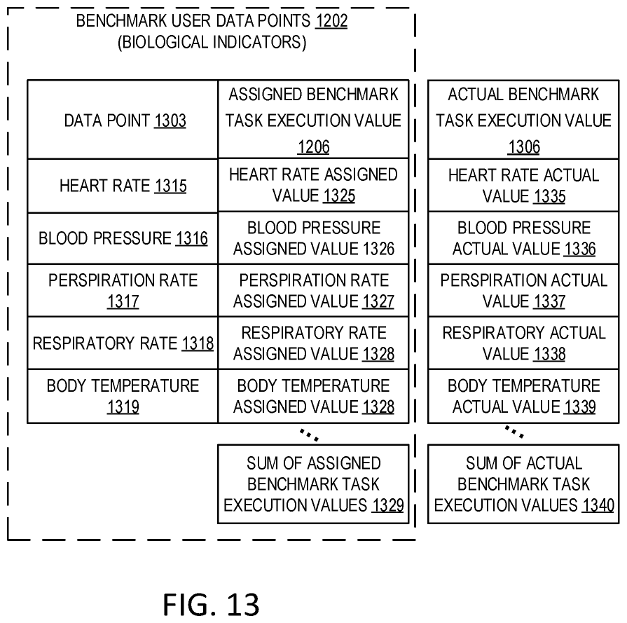

The benchmark task execution grade 1104 corresponds with benchmark user data 1102. Benchmark user data 1102 may have an associated benchmark task execution value 1106. A benchmark task execution value 1106 may be an arbitrary value assigned to benchmark user data 1102. The benchmark task execution value 1106 may be reflective of an average user data value, an optimal, peak, or above average user data value, or the like. FIG. 12 is a block diagram of a benchmark user data point 1202 and overall benchmark task execution grade 1208. Benchmark task execution values 1106 may be combined to achieve an overall benchmark task execution grade 1208. For example, the (assigned) benchmark task execution values 1106 may be added together or averaged to form the overall benchmark task execution grade 1208. For example, benchmark user data 1102 may include a plurality of points, each point may include one of heart rate, breathing pattern, and perspiration rate, as will be described in relation to FIG. 13. Each (assigned) benchmark user data point 1202 may be assigned a task execution value 1106. For example, heart rate may be assigned a value of 10, breathing pattern a value of 10, and perspiration rate a value of 10. If the values are added, the overall benchmark task execution grade 1208 is 30. If the values are averaged, the overall benchmark task execution grade 1208 is 10. The benchmark task execution values 1106 and grades may be any number, percent, ratio, and the like. The benchmark task execution grades 1104 may be reflective of an average grade (e.g., average performance), an optimal or peak grade (e.g., above average or excellent performance), or the like. Assume that the element labeled 670 denoted the task execution metrics calculator. While the symbol is intended to represent addition of values, the calculator may determine an average of the values, select a peak or maximum of the values, etc.

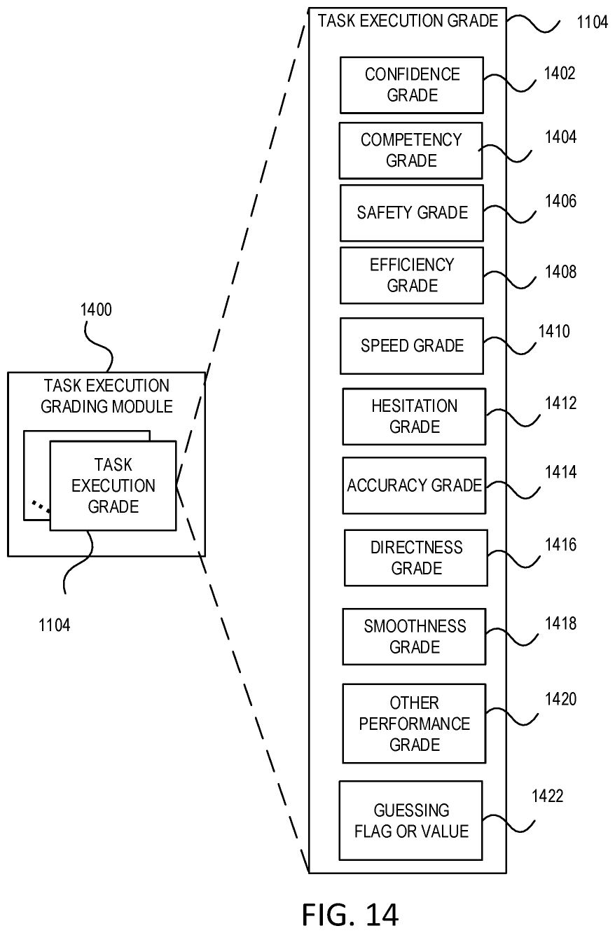

FIG. 14 is a block diagram of a task execution grading module 1400 to determine a task execution grade 1104. The collected user data and/or the determined associated task execution metrics are compared to the benchmark data, to determine a task execution grade 1104. The task execution grade 1104 may be determined as one or more of a confidence grade 1402, a competency grade 1404, a safety grade 1406, an efficiency grade 1408, a speed grade (e.g., to complete the task) 1410, a hesitation grade (e.g., an amount of hesitation and/or a point in a task sequence where a user hesitates) 1412, an accuracy grade (e.g., of movement(s)) 1414, a directness grade (e.g., of movement(s)) 1416, a smoothness grade (e.g., of movement(s)) 1418, and the like (e.g., other performance grade) 1420. These grades may be used individually or they may be used together. In various embodiments, the grades may be independent of one another. As one example, a confidence grade 1402 may indicate the user's level of confidence in his or her actions while executing the task, as opposed to smart guessing, in which the user guesses correctly but has little to no confidence in his or her decisions while executing the task. The competency grade 1404 may indicate if a user can complete the task. A safety grade 1406 may indicate the user's level of precautions while performing a task with associated risks and/or dangers.

For example, the safety grade may be based on the user performing certain tasks or sub-tasks demonstrating the user's ability to follow or incorporate safety rules or inclusion of personal safety equipment. For example, the system may determine if the user handled electrical equipment safely or observed certain safety issues interjected into the task. A speed grade 1410 may track the time, as tracked by the timer component 615, from start to finish, for example, to complete one or more sub-tasks or the entire task. A risk or danger may be interjected into simulation task run. The monitoring may determine whether the user took precautions to minimize risk and/or danger, for example. An example, risk in electrical equipment may be a visibly loose or cut wire. A potential danger may include imminent use of a flammable substance in an environment with a flame. It should be understood, that it is prohibitive to describe each and every risk. However, equipment manufactures and Occupational Safety and Health Administration (OSHA) provide standards and/or requirements for equipment and workplace safety. A grading module would detect for a safety risk or danger in a simulation run and determine a user's response to the displayed risk or danger, such as for compliance with any policy, rules and/or regulations.

A hesitation grade (e.g., an amount of hesitation and/or a point in a task sequence where a user hesitates) 1412 may evaluate a length of time to start a task or sub-task from the previous task or sub-task. The hesitation grade 1412 may determine an amount of time to: a) pickup a particular object, b) move an object and/or c) manipulate or operate an object. As shown in FIG. 8, each task may have a timer component 615. However, one or more grading modules may include a timer component to measure the time associated with evaluated metrics of the grading module. The accuracy grade (e.g., of movement(s)) 1414 may be based on detected movement expected to complete the task, precision of operating a particular machinery or object, or other metric representation of accurately performing a task or sub-task. The accuracy monitoring may determine if the user followed a particular preferred sequence of task or sub-task execution. If the preferred sequence was not performed, then any deviations may be evaluated. For example, the accuracy grade may be based on a set of possible sequences of movements, user selections or object manipulations. The sequences may be ranked from least accurate to most accurate of performance. In some scenario, accuracy is a function of entering a selection representative of an expected selection of success. A selection may be entered but the selection was wrong or a failure.

A directness grade (e.g., of movement(s)) 1416 may be based on expected movements representative of directness. The movements may be based on image processor or inertial measurements. For example, if the directness grade for any sub-task or task is based on the user operating object B after operating object A to object B in a simulation run, The directness grade 1416 may determine whether the user moved their hands directly from object A to object B.

The smoothness grade (e.g., of movement(s)) 1418 may be based on expected movements representative of smoothness. The smoothness grade 1418 may determine whether the user's movement from object A to object B was representative of smoothness. For example, non-smoothness may include observing the user making a first with a hand or other hand gestures. Likewise, the system may monitor for smooth motion rather than intermittent motion between tasks or sub-tasks.

The task execution grading module 1400 may include one or more processing elements which may be implemented using hardware, firmware, software or a combination of any of these. For instance, each processing element may be configured to determine a respective one grade of grades 1402-1420, for example. The processing element may be implemented as part of a microcontroller, processor, and/or graphics processing units. A corresponding grading module using image data or motion data may include programming instructions for image processing, feature extraction or motion tracking. Some motion tracking may use inertial measurements.

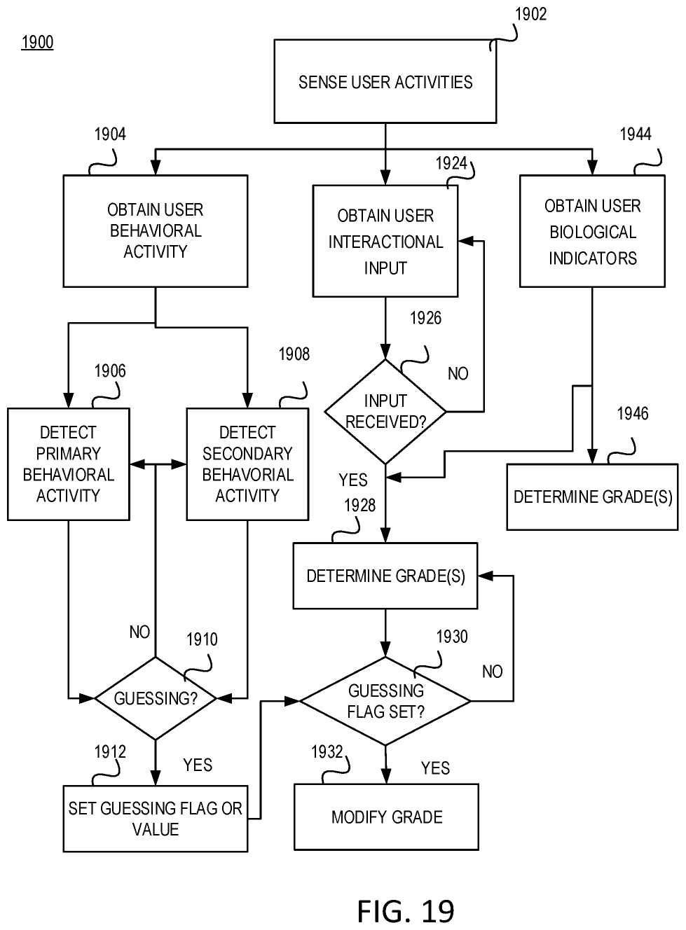

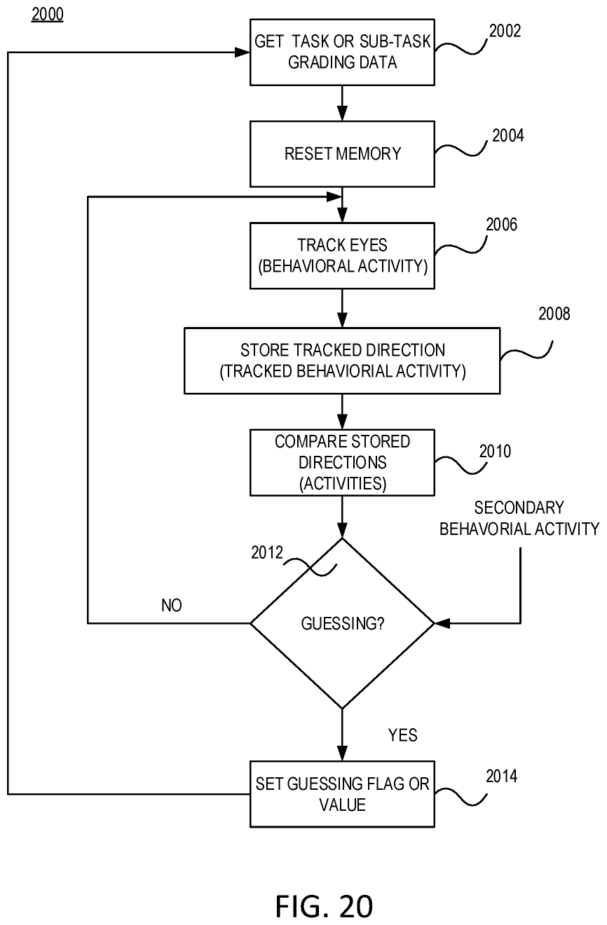

In some embodiments, multiple task execution grades may be determined from the collected data. However it is appreciated that different results can be determined. For example, a user may successfully complete a task with efficiency or safety but the confidence grade 1402 may indicate that guessing was likely involved, as will be described in more detail in relation to FIGS. 19 and 20. The task execution grading module 1400 may include a guessing flag or value 1422 that may be used to adjust the confidence grade 1402, for example. The guessing flag or value 1422 may be used to adjust other grades of the task execution grades 1104 for a particular task or sub-task.

In several embodiments, the task executed may include one or more sub-tasks. For example, a user may need to turn the key, push on the brake, change gears, release the brake, and push on the accelerator in a particular sequence of sub-tasks. It is contemplated that each sub-task may be assessed together or separately. In the example, where each task is separately assessed, a task execution grade 1104 may be generated for each sub-task. In some examples, an overall task execution grade 1208 may be generated from the sub-task task execution grades. By assessing each sub-task, areas of weakness in the performance of the task (e.g., the sub-tasks with a lower task execution grade) can be determined. Thus, the benchmark task execution grade 1104 may be a benchmark sub-task execution grade.

In several embodiments, two or more simulation runs may be executed with the same user executing the same task. The user's task performance may be evaluated during each run to assess changes in the user's task performance over time. The change in task performance over time can indicate whether there is performance improvement, whether the user is learning versus performing previously learned tasks, and the user's learning ability. For example, performance improvement may indicate a high probability the user learned from the prior simulation run, and in the subsequent simulation run is applying the learned skills. As another example, no or little improvement (e.g., consistent performance) may indicate a high probability the user applied previous knowledge when executing the task. In some embodiments, sub-task performance may be evaluated to assess changes in each sub-task performance over time. The task 662 may be measured or determined as a function of one or more grades per task and/or sub-task.

Each task or sub-task may include a different set of grades to determine the task performance 662. However, a scenario may be evaluated on a plurality of tasks and a plurality of sub-tasks. In some embodiments, the order of tasks or sub-task may vary or the scenario may be adapted based on the grades. The adaptation of the scenario may increase the complexity of the scenario being run at any instantiation. The adaptation may also decrease the complexity of the scenario being run at any instantiation, such as if it is determined the task is more complex than the skill set of the user being evaluated or trained.

FIG. 13 is a block diagram of benchmark user data points 1202 for use in determining an overall benchmark task execution grade associated with biological indicators. The data points 1303 may include one of heart rate 1315, blood pressure 1316, perspiration rate 1317, breathing pattern (i.e., respiratory rate 1318), and body temperature 1319, for example. Other biological indicators may be included, but for the sake of brevity, those listed will be described. The data point 1303 may include an assigned benchmark task (or sub-task) execution value 1206. For example, in this illustration, there are a heart rate assigned value 1325, blood pressure assigned value 1326, perspiration rate assigned value 1327, respiratory rate assigned value 1328, and body temperature assigned value 1329. As a user performs the task and responses are measure, an actual benchmark task execution value 1306 may be calculated for each point. The values 1306 may include a heart rate actual value 1335, blood pressure actual value 1336, perspiration rate actual value 1337, respiratory rate actual value 1338, and body temperature actual value 1339. The task assessment subsystem 640 may calculate or sum the assigned benchmark task execution values 1329 and sum the actual benchmark task execution values 1340 so that these values 1329 and 1340 may be compared with each other to determine success or failure of the task or any sub-task.

The benchmark user data points 1202 are described in relation to the biological indicators. However, benchmark user data points 1202 may be determined for data points associated with user interactional input and data points associated with behavioral user activity. The summed data points may vary from one task or sub-task to another as some data points may be eliminated from any calculations.

The present systems and methods are useful for assessing a user's ability to execute a task and/or respond to certain stimuli (e.g., emergency situations) in a simulated environment. The present systems and methods have broad application. For example, it may be useful to evaluate a user's task performance for a company seeking to hire an employee with a particular skill set and skill level or for evaluating current employees to determine training needs to improve employee performance.

A simulated reality environment may also be referred to herein as a simulated reality layout, simulated reality layer, or simulated reality experience. Simulated reality systems can be displayed on two-dimensional (2D) devices such as computer screens, mobile devices, or other suitable 2D displays. Simulated reality systems can also be displayed in 3D such as on a 3D display or hologram. Examples of simulated reality include virtual reality (VR), augmented reality (AR), mixed reality, and traditional 3D representations on a 2D display. Simulated reality systems immerse users in environments that are either partially or entirely simulated. In AR environments, users interact with real world information via input sensors on the device, providing a partially simulated environment. In VR environments, the user is fully immersed in a 3D simulated world via, for example, a headset or similar hardware. Each type of simulated reality system may have objects or assets that are simulations of (i.e., corresponds to) real world items, objects, places, people, or similar entities. The objects or conditions can also provide feedback through haptics, sound, visual, or other suitable methods.

The user device(s) 102a-n can also have one or more sensors 103, similar to one or more sensors 112, for detecting data that is indicative of a condition attribute of the user. For example, the user device(s) 102a-n may have a biofeedback sensor(s) 908 (e.g., a body temperature sensor 918 for detecting the user's body temperature, a heart rate monitor 910, a blood pressure monitor 912, etc.). Alternatively or additionally, one or more sensors 112 or 103 may be separate from the user device(s) 102a-n and in communication over the network 104. The one or more sensors 112 or 103 may include any sensor for measuring user responses and/or actions. For example, the sensor may measure user responses and/or actions related to confidence, as discussed in more detail below.

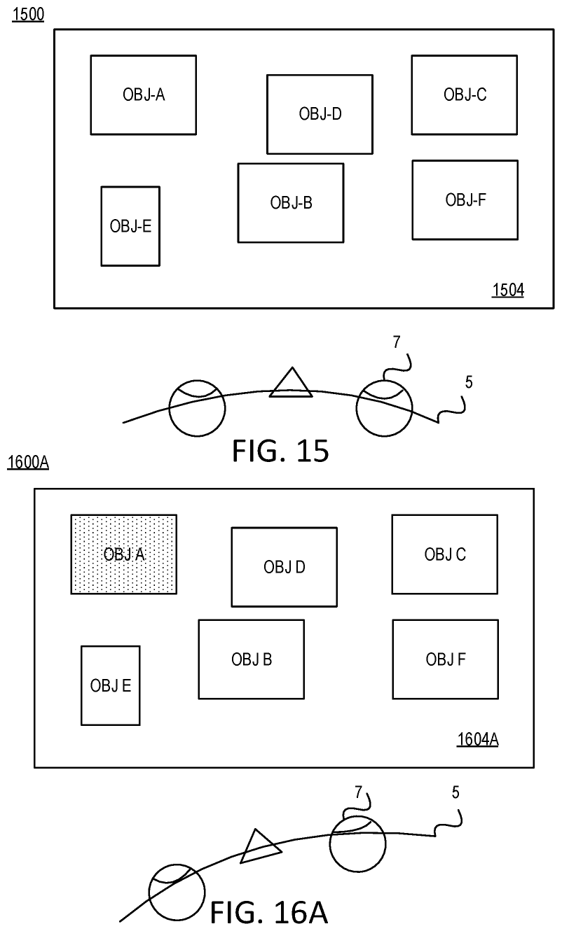

FIG. 15 is an example simulated reality scenario 1500 of a task or sub-task with a user observing the simulated reality scenario 1500. Assume for this example, the simulated reality scenario 1500 includes a workbench 1504 displayed on a display device to the user in augmented reality, virtual reality or simulated realty. A plurality of objects OBJ A, OBJ B OBJ C, OBJ D, OBJ-E and OBJ-F are shown on top of the workbench 1504 in some order. The A-F references denote and order. However, the order is unknown to the user for the task or sub-task. The user is represented by face 5 of a user's head and eyes 7. In an image, each object may correspond to a registered different region of interest.

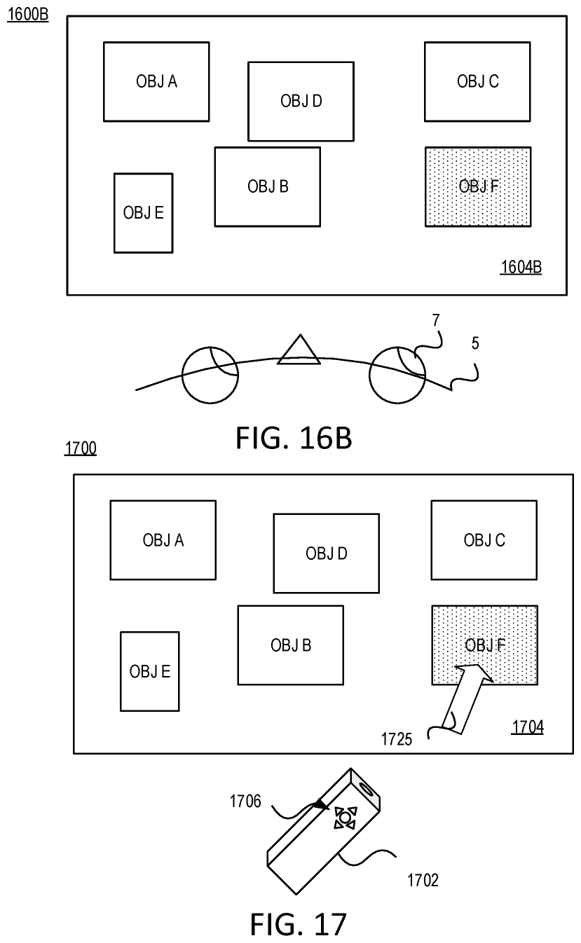

FIG. 16A is an example simulated reality scenario 1600A tracking a user's head direction relative to the simulated reality scenario of the task or sub-task of FIG. 15. Assume that the object OBJ-A is the first object expected by the system to be interacted with by the user for the task or sub-tasks. In FIG. 16A, object OBJ-A on workbench 1604A is shown with dotted hatching to represent that movement of the user's head, as detected by the sensors 112 or 103, in the direction of object OBJ-A. Assume that the dotted hatching denotes a user selection. For example, the user's eye gaze may have been directed to object OBJ-A for a predetermined time to determine selection. The system may have required other inputs to determine a user's interaction input. Accordingly, the object OBJ-A is represented with dotted hatching as a user interactional input of object OBJ-A. Assume that object OBJ-A is an accurate selection made with confidence because, the user immediately moved their head (and thus their eyes 7) toward the object OBJ-A being expected by the system for input selection. Hence, an accuracy grade may use the head movement in the direction of object OBJ-A and/or gaze direction of eyes 7, by way of non-limiting example.

FIG. 16B is an example simulated reality scenario 1600B tracking a user's eye direction relative to the simulated reality scenario of the task or sub-task of FIG. 15. Assume that the object OBJ-A is the first object to be interacted with by the user for the task or sub-tasks. In FIG. 16B, object OBJ-F on workbench 1604B is shown as a dotted hatched box to represent that the user's eye movement, as detected by the sensors 112 or 103, denotes the selection of object OBJ-F by the user. The user may have also moved their head or face 5 in the direction of OBJ-F which would have caused the system to select, as a user interactional input, the object OBJ-F instead of using the direction of eye gaze of eyes 7. However, the system is expecting as user interactional input selection of object OBJ-A. Thus, the movement of eye gaze of the eyes 7 may indicate hesitation, guessing, etc., as previously described in relation to FIG. 14, if the user glances back toward object OBJ-A and then interacts with object OBJ-A. Thus, a hesitation or guessing grade may be calculated accordingly but the user may have been successful in performing the task.

Now assume that for the sake of discussion, the simulated reality scenario has advanced to a task or sub-task requiring OBJ-F to be interacted with or selected by the user for the current task or sub-task. Accordingly, the user has moved their eye gaze in the direction of object OBJ-F which would have caused the system to select as input object OBJ-F where object OBJ-F is the accurate selection. Accordingly, this task or sub-task may have been performed with confidence with little to no hesitation or guessing.

FIG. 17 is an example simulated reality scenario 1700 tracking a user's interactional input to the simulated reality scenario of the task or sub-task of FIG. 15 using a hand-held controller 1702, such as a user device. In the scenario 1700, the system detects the use of a hand-held controller 1702 as a user device for input. The user may point the controller 1702 in the direction of the object OBJ-F to select the object OBJ-F. The selected object OBJ-F on workbench 1704 is denoted as a box with dotted hatching. In other embodiments, a mouse or other user input device may be used. The system may detect hovering of a graphical user interface selector 1725, controlled by controller 1702, over object OBJ-F for a period of time to select the object, for example. In other embodiments, the user may use controller 1702 to enter a section by manually activating a particular selection button 1706 on the hand-held controller 1702.

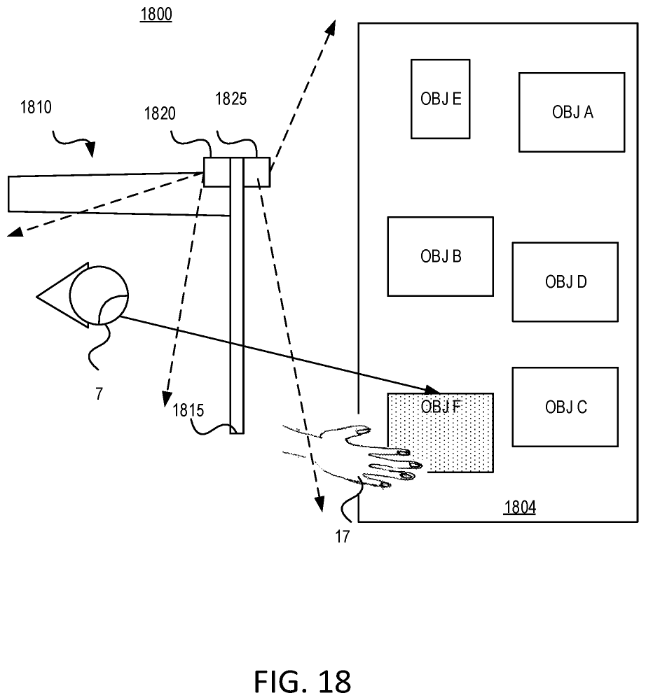

FIG. 18 is an example simulated reality scenario 1800 tracking a user's interactional input to the simulated reality scenario of the task of FIG. 15 using a mixed reality hardware platform. In FIG. 18, the user may wear a head-mounted display (HMD) device 1810 which includes an eye tracker sensor 1820 directed toward the user's eyes 7. The HMD device 1810 may include camera 1825 have a field of view in the direction of a real world environment with a workbench 1804 captured in the field of view. The workbench 1804 may include real world objects, virtual objects or a combination of real and virtual objects. The system may display simulated virtual reality objects which may be displayed to appear on workbench 1804.

The camera 1825 may capture the user's hands in its field of view while interacting with objects on the workbench 1804. In some embodiments, the camera 1825 may detect that the user's actual hands are touching a real object or hovering over a virtual object. In the illustration, the user's hand 17 is shown touching or hovering over the region of interest associated with object OBJ-F. Thus, the object OBJ-F is represented as a dotted hatching to denote user selection.

The HMD device 1810 may also include sensors, such as an IMU, to determine head motion and orientation to determine behavioral activities, such as for determining whether the user is guessing, hesitating, being direct, acting smoothly. The behavioral activities may be used to access a grade associated with speed of or time for performing the task or sub-task. The camera 1825 may be used to determine other user behavioral activities for determining guessing or hesitation. The HMD device 1810 may include a lens or display 1815 depending on the configuration of the HMD device.

FIG. 19 is a flow chart illustrating a task grading method 1900 for a task or sub-task during a simulation task run representative of the simulated reality scenario. The method 1900 may include, at operation 1902, sensing user activities, behaviors and biological indicators during the simulation task run. The sensing may be performed by the user monitoring subsystem 610. The method 1900 may include, at operation 1904, obtaining user behavioral activity. The method 1900 may include, at operation 1924, obtaining user interactional input. The method 1900 may include, at operation 1944, obtaining user biological indicators. One or more of the behavioral activities may be used to determine guessing. One or more behavioral activities may be used to determine interactional input. One or more of the biological indicators may be used to determine guessing, hesitation, stress, and other grades as described herein.

The method 1900 may include, at operation 1906, detecting one or more primary behavioral activities and, at operation 1908, detecting one or more secondary behavioral activities. The method 1900 may include, at operation 1910, determining whether guessing is being performed by the user, in response to the detected primary and/or secondary behaviors. If the determination, at operation 1910, is “NO,” operation 1910 proceeds back to operations 1906 or 1908. If the determination at operation 1910 is “YES,” then operation 1910 proceeds to operation 1912 where a guessing flag is set or a guessing value is determined. The guessing value may be in a range of 0-4 to represent guessing out of 10. Values of 5-10 may represent little to no guessing.

Returning again to operation 1924, the method 1900 may include, at operation 1926, determining whether the sensed data representative of interaction input has been received. If the determination at operation 1926 is “NO,” the method 1900 may return to operation 1924. If the determination at operation 1926 is “YES,” then the method 1900 will proceed to operation 1928. The method 1900 may include, at block 1928, determining one or more grades, such as described in relation to FIG. 14, for the task or sub-task. The method 1900 may include, at operation 1930, determining whether a guessing flag is set or a guessing value is provided. If the determination is “NO,” then the method 1900 loops back to block 1928 where the grade is not adjusted. However, if the determination is “YES,” then method 1900 proceeds to operation 1932 to modify the grade based on the guessing flag or value.

Returning again to operation 1944, the biological indicators may be used to determine grades in operation 1946 and/or grades during operation 1928. The grades as determined at operation 1928 or 1932 and grades 1946 may be used to determine an overall task execution grade 1208 of FIG. 12. Grades are also described in relation to FIG. 14.

FIG. 20 is a flow chart illustrating a guessing method 2000 for uses in the task grading method of FIG. 19, wherein operations 2002-2010 may be performed by operation 1906. The method 2000 may include, at operation 2002, getting task or sub-task grading data associated with a scenario. The grading data represents the information for the particular task or sub-task for which the system is expecting. This information may include registered objects in the displayed image of a scenario (i.e., scenario 1500). The method 2000 may include, at operation 2004, resetting or initializing memory used to store behavioral activity. The method 2000 may include, at operation 2006, tracking eyes (primary behavioral activity). The method 2000 may include at operation 2008, storing the direction of eye gaze relative to the scenario or registered objects of the scenario. The method 2000, at operation 2010, may compared stored directions. If the stored directions only include one direction, the comparison would not indicate guessing because there was only one direction. The method 2000, at operation 2012, may determine whether the user is guessing. If the determination is “NO” the method loops back to operation 2006 so that the tracking of the eyes is continued. However, if the determination is “YES,” the method proceeds to block 2014 where a guessing flag is set or a value is determined. The method 2000 may include looping back to block 2002 to get information associated with the next task or sub-task of the scenario.

Returning again to operation 2012, the method 2000 may include providing information associated with the secondary behavioral activity to operation 2012 to determine whether guessing is being performed by the user when performing the task or sub-tasks.

While the example of method 2000 describes tracking of the eyes, the method 2000 may be used for any user behavioral activity such as movement of the user's head, and movement of the user's hand or other body part.

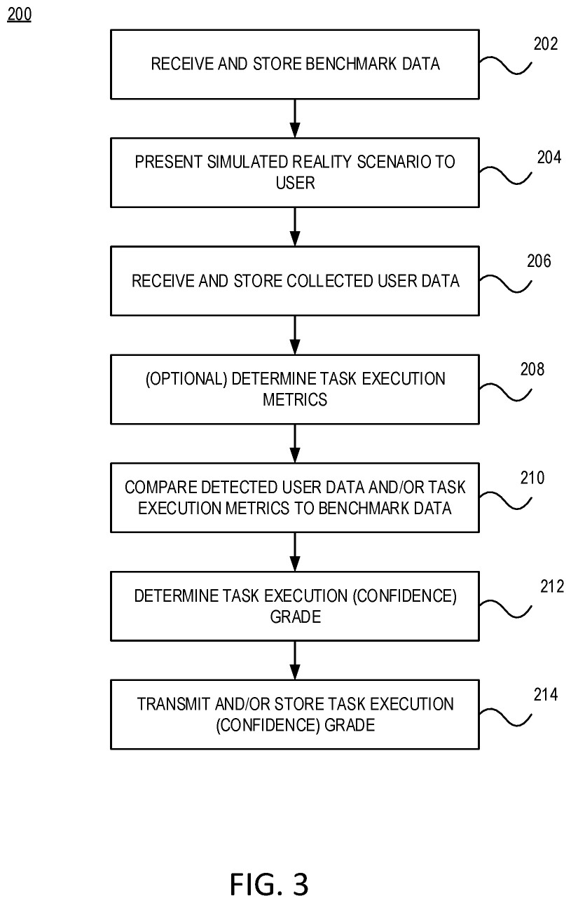

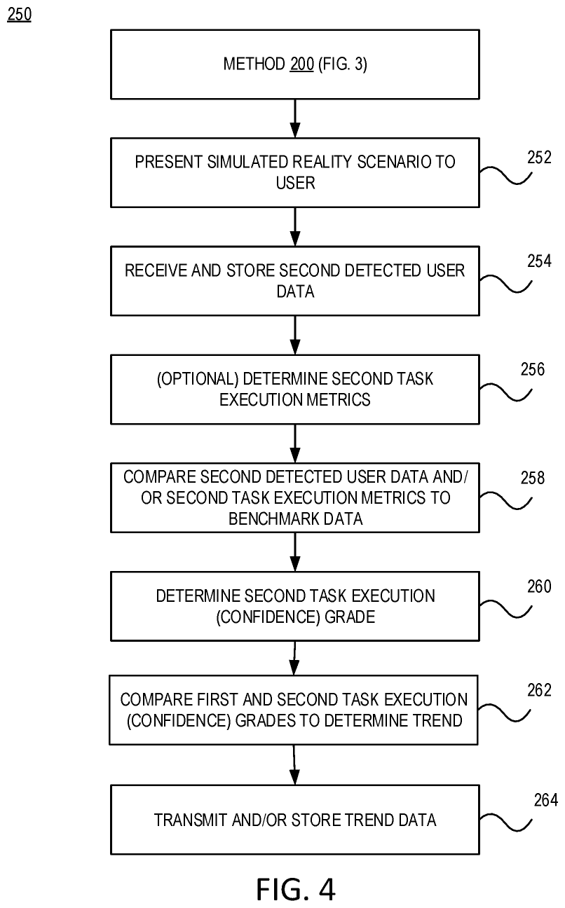

FIG. 3 is a flowchart illustrating a method 200 for evaluating a user's interaction with a simulated reality environment. The method 200 may be carried out by one or more processing elements 152. The method 200 begins with operation 202 where benchmark task execution data is received and stored by the one or more processing elements 152 over the network 104 or a communication network which may be wired and/or wireless. The benchmark task execution data may be stored in memory components 158 and/or database(s) 108. Benchmark task execution data may include benchmark data 648A or user benchmark data 648B and associated benchmark task execution grades. The benchmark data 648A or user benchmark data 648B may include data related to biological indicators, user interactional input, and behavioral user activity, as discussed above. For example, biological indicators may include heart rate, blood pressure, temperature, perspiration rate, respiratory rate, breathing patterns, neurological activity, and the like. As another example, user interactional input may include how the user interacts with a simulated reality environment. For example, user interactional input may include body movement, micro-movements, decisions/selections (e.g., between different objects, between different directions/paths, etc.), and the like. Behavioral user activity may include activity and/or responses that subsequently occur as the user interacts with the environment. For example, behavioral user activity may include eye movement, speech patterns, facial expressions, and the like.

In some embodiments, the benchmark data 648A or 648B may be obtained from one or more benchmark users (e.g., different from the current user) performing the same or similar task in the same or similar simulated reality environment. In some embodiments, the one or more benchmark users may have ordinary skill at executing the associated task. For example, the one or more benchmark users may be proficient at the task. The one or more benchmark users may be a professional in the field associated with the task (e.g., a doctor for a surgical task, a forklift driver for a forklift operation task, a mechanic for a car repair task, etc.). Benchmark data 648A may be measured, collected, and stored as the one or more benchmark users execute the same task in the same simulated reality environment. In some embodiments, a single benchmark user may execute the task and create a benchmark value for one or more user-related measurements (e.g., the user data discussed above). The benchmark user data created by the single benchmark user may be a threshold or target user data value. In some embodiments, a plurality of benchmark user data may be measured, collected, and stored from a plurality of benchmark users executing the same task in the same simulated reality environment. In some embodiments, the plurality of benchmark user data creates a benchmark value range for the user data measurements. For example, the plurality of benchmark users may have desirable, but varying skill levels, resulting in the value range. In some embodiments, the plurality of benchmark data may be averaged to create an average benchmark value for the user data measurements. Because user data may vary based on gender, age, and the like, the benchmark user data may be divided by gender and/or age, or the like, and stored by the system by the one or more processing elements 152 in memory components 158, for example.

In an alternate embodiment, the user benchmark data 648B may be obtained from the current user via the user monitoring subsystem 610. The current user is the user who performs a simulation run for task execution assessment (e.g., for confidence assessment). In this embodiment, the current user may also perform an initial simulation run as a benchmark or baseline simulation run to compare against future simulation runs for task execution assessment. In some embodiments, the current user may perform the same or similar task in the same or similar simulated reality environment as the future simulation run for task execution assessment. In some embodiments, the current user may perform a simple benchmark simulation run in which the user performs a simple everyday task (e.g., a task different from the task associated with the future simulation run for task execution assessment). The simple everyday task may be, for example, brushing teeth, doing laundry, making a sandwich, and the like. Benchmark user data may be measured, collected, and stored as the current user executes the everyday task. In this embodiment, the benchmark user data indicates baseline user data values specific to the user when the user is performing a known task with a strong skill level for executing that task. One or more of these benchmark simulation runs may be executed. In one example, multiple benchmark simulation runs may be executed, and the benchmark user data collected may be averaged to obtain more accurate baseline values. In some embodiments, a challenging benchmark simulation run may include a challenging task that is very difficult to impossible to perform. In these embodiments, the benchmark user data collected may indicate extreme or peak deviations from the baseline user data values, indicating the user is performing an unfamiliar task with little to no skill level for executing that task. In some embodiments, both the benchmark user data collected from the challenging benchmark simulation run and the benchmark user data collected from the simple benchmark simulation run may be used to create a range of values including values indicating a low to zero skill set (and, in some examples, a low confidence level) and values indicating a strong skill set (and, in some examples, a high confidence level).

In some embodiments, the benchmark user data may be assigned task execution grade value(s) and/or grade(s). User data may be indicative of qualitative information related to task execution. For example, user data may be indicative of action confidence vs. hesitation, knowledge vs. guessing, safety/care, attention, consideration/thoughtfulness, and the like. For example, a steady heart rate, low blood pressure, low perspiration rate, focused eye and body movements, and the like may indicate strong performance and/or confident, focused, competent, and/or thoughtful action. In one example, user movement (including delay time and direction of movement) may be indicative of skill/knowledge. Focused or focused eye may be a function of an amount of time the user's eye gaze or head direction was essentially stationary on an object. Essentially stationary would be movement within a narrow angle of movement. The term “strong performance” may be based on a value within a range of values designated be being representative of “strong performance.” A “thoughtful action” may be a detected action representative of thoughtful. In other words, the action may not be necessary but would (i) prevent a potential hazard, (ii) clean up a mess, or (iii) other representative action. For example, a simulation may involve a machine with several buttons that need to be selected in a particular order. If a user spends a significant amount of time looking at the wrong button or moves towards the wrong button first, then the system, using the one or more processing elements 152, may determine that the user is less skilled/knowledgeable in operating the machine than had the user immediately selected (e.g., looked and moved towards) the correct button. In several embodiments, the qualitative information may be represented by one or more benchmark task execution grades. For example, in the above example, a delay time of 5 seconds to select the correct button may be given a grade of 100, such that a user is considered to have skill/knowledge in operating the machine if the user takes a 5 second delay before selecting the correct button. However, if the user takes longer than 5 seconds to select the correct button, the grade may accordingly deviate from 100, and the user will be considered to have less skill/knowledge in operating the machine.

In several embodiments, user data is indicative of a confidence level. For example, one or more of the biological indicators, user interactional input, and other user action may be indicative of a user's confidence level as the user executes a task in the simulated reality environment. For example, one or more of a calm or substantially resting heart rate, low perspiration rate, low blood pressure, normal body temperature (e.g., 37° C.), steady respiratory rate, and the like, may be indicative of a high level of confidence. As another example, focused, directed, and steady body movement may be indicative of a high level of confidence. For example, a user reaching directly towards a correct simulated reality object (e.g., an appropriate tool for the task), grabbing the correct side or end of the simulated reality object (e.g., the handle of the tool), properly positioning his or herself relative to one or more simulated reality objects, and the like, may be indicative of a high level of confidence. When a timing component is included, a quick reaction time or speed of movement towards a correct simulated reality object may be indicative of a high level of confidence. As another example, focused, directed, and steady eye movement may be indicative of a high level of confidence. As another example, calm speech and/or relaxed facial expressions may indicate a high level of confidence. The above examples are not meant to be limiting and other user actions may be indicative of a confidence level. For example, patterns detected in the benchmark user data may be indicative of a biological indicator, user interactional input, and/or other user action that is indicative of a confidence level (e.g., patterns tracked by an analytics based AI system).

Alternatively, the same or similar user data may also indicate guessing or lack of confidence. For example, one or more of the biological indicators, user interactional input, and other user action may indicate that a user is guessing or lacks confidence as the user executes a task in the simulated reality environment. For example, one or more of an elevated heart rate, high perspiration rate, high blood pressure, raised body temperature, rapid respiratory rate, heavy breathing, and the like, may indicate that the user is guessing and/or lacks confidence in his or her actions. As another example, sporadic, undirected, and/or timid body movement, or the like, may be indicative of guessing or a lack of confidence. For example, a user reaching towards an inappropriate simulated reality object first (e.g., the wrong tool for the task), grabbing the wrong side or end of a simulated reality object, positioning his or herself in an awkward or inappropriate position relative to one or more simulated reality objects, and the like, may be indicative of guessing or a lack of confidence. When a timing component is included, a slow reaction time or speed of movement towards a simulated reality object may indicate a high probability the user is guessing. For example, a slow reaction time may indicate hesitation in the user's actions. As another example, unfocused or rapid eye movement may be indicative of guessing or a low level of confidence. For example, a user looking in multiple directions or in a direction away from the correct simulated reality object may indicate a high probability the user is guessing when the user takes action. As another example, harsh speech and/or concerned facial expressions may indicate a high probability of guessing. The above examples are not meant to be limiting and other user actions may be indicative of guessing or a low level of confidence.

In some embodiments, benchmark user data may have an associated benchmark task execution value. A benchmark task execution value may be an arbitrary value assigned to the benchmark user data. A benchmark task execution value may be reflective of an average user data value, an optimal, peak, or above average user data value, or the like. The overall benchmark task execution grade may be determined by combining benchmark task execution values. For example, benchmark task execution values may be added together or averaged to form the overall benchmark task execution grade. For example, benchmark user data may include heart rate, breathing pattern, and perspiration rate. Each benchmark user data point may be assigned a task execution value. For example, heart rate may be assigned a value of 10, breathing pattern a value of 10, and perspiration rate a value of 10. If the values are added, the overall benchmark task execution grade is 30. If the values are averaged, the overall benchmark task execution grade is 10. The benchmark task execution values and grades may be any number, percent, ratio, and the like. The benchmark task execution grades may be reflective of an average grade (e.g., average performance), an optimal or peak grade (e.g., above average or excellent performance), or the like. For example, a benchmark task execution grade may be reflective of an average confidence level, an optimal confidence level, a peak confidence level, or the like.

In some embodiments, a single benchmark task execution grade may be generated from the one or more benchmark task execution values that is indicative of one or more qualities of task performance. For example, a single task execution grade may be a confidence grade indicating the user's level of confidence in the associated task. As another example, the task execution grade may be a confidence grade indicating the user's level of confidence in his or her actions while executing the task (e.g., as opposed to smart guessing, in which the user guesses correctly but has little to no confidence in his or her decisions while executing the task). As yet another example, the task execution grade may be indicative of both confidence and guessing. As one example, a benchmark user may execute a task with a steady heart rate of 70 bpm. A steady heart rate of 70 bpm may be assigned a task execution grade of 100. A grade of 100 may indicate, for example, one or more of 100% competency, confidence, and/or performance skill. As another example, a steady heart rate of 70 bpm may be assigned a task execution grade of 50 indicating one or more of average competency, confidence and/or performance skill. In other words, a grade below 50 would be under average, while a grade above 50 would be above average.

In some embodiments, a plurality of grades may be generated from the user data. In some examples, the grades may be specific to the task. For example, the task execution grade may include a safety grade if the task has associated dangers and/or risks. In these embodiments, some user data may be grouped together to create one grade, while other user data may be grouped together to create another grade. For example, heart rate, perspiration rate, and reaction time may be grouped together to determine a confidence grade (e.g., a steady heart rate, low perspiration rate, and quick reaction time may indicate a high confidence grade), while eye movement, body movement, and reaction time may be grouped together to determine an attention grade (e.g., focused eye movement and body movement and a quick reaction time may indicate a high level of attention). As demonstrated, user data may or may not be exclusive to a grouping of user data to provide a particular assessment of the user's task performance. Further, the different grades may be combined (e.g., added, averaged, or the like) to determine an overall performance grade. For example, the overall performance grade may indicate very strong performance, strong performance, average performance, below average performance, poor performance, inadequate performance, or the like. For example, a high confidence grade (e.g., near 100% confidence) and a high level of attention (e.g., near 100% attention level) may generate a high overall performance grade indicating very strong performance.

In some embodiments, the benchmark data (e.g., the stored benchmark user data and/or associated benchmark task execution grades) may be arbitrary values randomly established by the system or an administrator. For example, an administrator (e.g., an employer, trainer, etc.) may input values that he or she thinks are indicative of good performance. For example, an administrator may assign 100% quality performance (e.g., very strong performance) to a steady baseline heart rate (e.g., 50-70 bpm), steady, accurate, and quick (e.g., less than 10 seconds) movements, steady and focused eye movements, and the like.

While the above examples are provided with respect to measuring good/strong performance and/or confidence/guessing, and the like, it is also contemplated that the grades may reflect bad/poor performance and/or hesitation/lack of confidence, and the like.

After operation 202, the method 200 may proceed to operation 204 and a simulated reality scenario is presented to a user. The simulated reality scenario is related to a real world scenario. For example, the simulated reality scenario may include a task that a user would encounter in the real world. As one example, the task may be specific to a profession (e.g., repairing a car engine, building a cabinet, driving a forklift, performing a surgery, etc.). As another example, the task may be handling a difficult or uncomfortable situation (e.g., public speaking, a negotiation, an emergency, etc.). The simulated reality scenario may include a simulated reality environment with simulated reality assets or objects. For example, the simulated reality objects may include objects used to complete the task (e.g., tools). In some examples, the simulated reality objects may also include distracting objects, such as tools that cannot be used to complete the task, to further assess the user's understanding of the task. In several embodiments, the system, using the one or more processing elements 152, is capable of monitoring the position of one or more simulated reality objects throughout a simulation run. In some embodiments, the simulated reality scenario may remain constant throughout one or more simulation runs. In other embodiments, the simulated reality scenario may change over the course of a single simulation run or over the course of several simulation runs if several runs are executed (e.g., to measure the user's ability to adapt to a changing environment, as often happens in a real world environment).

After operation 204, the method 200 may proceed to operation 206 where detected user data is received and stored. As the user interacts with the simulated reality environment (e.g., performs a task within the simulated reality environment), user data is measured and detected by the user monitoring subsystem 610 of the system. The detected user data (e.g., 648B) may be similar or the same as the benchmark user data. For example, the detected user data (e.g., 648B) may include data related to biological indicators, user interactional input, and behavioral user activity, as discussed above. For example, biological indicators may include heart rate, blood pressure, temperature, perspiration rate, respiratory rate, breathing patterns, and the like. As another example, user interactional input may include how the user interacts with a simulated reality environment. For example, user interactional input may include body movement (e.g., hand movement), decisions/selections (e.g., between different objects, between different directions/paths, etc.), and the like. Behavioral user activity may include activity and/or responses that subsequently occur as the user interacts with the environment. For example, behavioral user activity may include eye movement, speech patterns, facial expressions, and the like.

In several embodiments, the detected user data is measured relative to one or more simulated reality objects. For example, as will be described in relation to FIG. 18, the system using a mixed reality hardware platform, may monitor the position of a real object in the environment and the user's position/change in position relative to the object. For example, hand movement and eye movement may be measured relative to one or more real objects. The system using an augmented or virtual reality objects, may register the position of a computer-generated object in the image of the displayed environment and the user's position/change in position relative to the registered object. For example, hand movement and eye movement of the user may be measured relative to one or more registered simulated reality objects in the displayed image. As an illustrative example, the simulated reality environment may include a machine with several buttons and the task is to operate the machine. In this example, there may be a proper order to push the buttons to operate the machine. In this example, hand movement and/or eye movement relative to each button may be measured to assess the user's knowledge for which button to press and when. As another example, a user's reaction to one or more simulated reality objects may be assessed based on the detected user data. For example, a user's heart rate, breathing pattern, blood pressure, perspiration rate, temperature, and the like, may be measured as an object is presented to a user. For example, in a simulated flight task, a flock of birds may be introduced in the user's flight path, and the user's reaction to these simulated objects may be measured. Measuring a user's reaction to simulated objects may indicate, for example, how adept the user is at handling stressful/emergency situations.

The detected user data may be measured by one or more sensors. For example, the one or more sensors 112 may include an optical sensor 902, motion sensor 904, audio sensor 906, eye tracker 920, heart rate monitor 910, body temperature sensor (e.g., thermometer) 918, blood pressure monitor (e.g., a sphygmomanometer) 912, perspiration sensor (e.g., electrodes) 914, respiratory sensor 916, voice recognition module 942, facial recognition module 946, and the like. As one example, an optical sensor 902 may be a camera that captures a moving or still image associated with the user's movement and decisions. Various image processing techniques may be performed on the captured image to assess user movement. For example, a sequence of captured images may indicate the user initially grabbed one object before reaching for the other object. As another example, a motion sensor 904 may be used to detect where a user moves and the speed of user movement. As yet another example, an eye tracker 920 may follow a user's eye movements to assess speed of movement, where the user looks and when, and the like. As another example, a heart rate monitor 910 may measure the user's heart rate/pulse as the user executes the task. Image processing techniques may include motion detection and background subtraction. The captured images may include spatial data mapped to x, y coordinates in an image. However, body-worn movement sensors 930 (FIG. 9A) may be used to determine movement of the user.

After operation 206, the method 200 optionally proceeds to operation 208 where one or more task execution metrics may be determined based on the measured user data such as from the sensors. The one or more task execution metrics may include, for example, reaction time, hesitation rate and/or amount, stress levels, and the like. For example, the system may also include a timing component (e.g., a timer) to monitor timing and duration of the user data measurements, as well as time in between different user data measurements or sub-tasks within the task. For example, a “START” graphic (e.g., a simulated reality object) may flash in front of the user and a timer may simultaneously begin to measure the time it takes for the user to reach for or grab a simulated reality object, or the user's reaction time to start the task. As another example, the system may determine the time in between sub-tasks to assess the user's hesitation in executing one task after the other.

After operation 206, or optionally after operation 208, the method 200 may proceed to operation 210 where the detected user data and/or the task execution metrics are compared to the benchmark data. As discussed, the benchmark user data may include a single value or a range of values. In the example where the benchmark user data is a single value, the benchmark user data value may be a threshold or an average value. In the example where the benchmark user data is a threshold value, the system determines whether the detected user data exceeds the threshold value (which can be a maximum threshold or a minimum threshold). For example, benchmark user data may be a threshold reaction time of 30 seconds (e.g., to grab the correct simulated reality object to execute a sub-task). As one example, a reaction time determined at operation 208 may be 20 seconds. The determined reaction time of 20 seconds falls below the maximum threshold benchmark value of 30 seconds. In this example, the user's reaction time may indicate a high confidence level. In the example where the benchmark user data is an average value, the system determines whether and the extent the detected user data diverges from the average value. For example, the benchmark user data may be a heart rate of 100 bpm. A heart rate falling above or below 100 bpm diverges from this average value. As one example, a heart rate monitored and detected, by the heart rate monitor 910, may be 120 bpm. This heart rate is higher than the average benchmark value of 100 bpm. In this example, the detected user data is above average and the above average heart rate value may be indicative of a heightened reaction to the simulated reality environment or task. As one example, a heightened reaction may be indicative of a low confidence level. In the example where the benchmark data is a range of values, the detected user data and/or determined task execution metrics are compared to the range to determine whether the detected data falls within the benchmark value range or outside the range. Detected data falling within the benchmark value range may indicate average performance (and/or average confidence level), while detected data falling outside the range may indicate below or above average performance (and/or a low or high confidence level). For example, a benchmark heart rate value range may be between 100 and 120 bpm. A detected heart rate of 120 bpm falls within this heart rate value range and may indicate average performance.

The comparison between the detected data and the benchmark data may account for individual variations (e.g., where the benchmark data is from a benchmark user and not from the current user). For example, user data may vary based on age, gender, health, disability, and the like. Therefore, detected user data may be considered to match benchmark user data even if there are slight variations in values when accounting for these individual differences. For example, the benchmark data used for comparison may be arranged based on user demographics or user profile.

After operation 210, the method 200 proceeds to operation 212 where a task execution grade is determined. The task execution grade is based on the benchmark task execution value or grade associated with the benchmark user data. Where the detected user data value and/or determined task execution metric matches the benchmark value, the task execution grade may be the same as the stored associated benchmark task execution grade. In some embodiments where the benchmark is a single value, and the detected user data value and/or task execution metric diverges from the benchmark value, the task execution grade may correspondingly diverge from the benchmark task execution grade. For example, a benchmark heart rate of 120 bpm may be associated with a grade of 10. The system may determine that a detected heart rate of 108 bpm corresponds to a grade of 9. In this example, the detected heart rate value is 10% lower than the benchmark heart rate value, and the associated grade is also 10% lower than the benchmark grade corresponding to the benchmark heart rate value. In some embodiments where the benchmark is a value range, and the detected value and/or task execution metric falls outside the range, the task execution grade may be low, indicating low performance and/or a low confidence level, for example.

As one example, a benchmark heart rate value of 70 bpm may be assigned a benchmark task execution grade of 100. In this example, the benchmark task execution grade 100 may be indicative of a high performance level (e.g., a competency level and/or a confidence level). If a user's detected heart rate value is 70 bpm or approximately 70 bpm (e.g., based on individual differences), the task execution grade is 100, and the user has a high performance level (e.g., a high level of competency, high confidence, near or at 100% performance level, etc.). Alternatively, differences between a user's recorded user data value and the benchmark user (e.g., a spike in the user's heart rate) may indicate a deviation from the benchmark and variations in competency and/or confidence (e.g., variations from 100% competency and/or confidence). For example, the task execution or performance grade may vary based on how many deviations there are from the benchmark and/or the degree of deviation from the benchmark. For example, a single spike in heart rate and/or a small spike in heart rate may not be as large of a deviation from the benchmark as a plurality of spikes in the heart rate and/or a large spike in the heart rate, such that the former results may indicate more competent performance or higher confidence level than the latter results.

After operation 212, the method 200 may proceed to operation 214 where the task execution grade is transmitted and/or stored. The task execution grade may be transmitted to a user device. For example, the task execution grade may be transmitted to the current user who executed the task or to another user, such as, for example, an administrator. The administrator may be, for example, a trainer, an employer, a human resource employee, and the like. The task execution grade provides feedback to the user. The task execution grade may be used, for example, to assess whether to hire a candidate. For example, the task execution grade may indicate a candidate's ability to perform tasks specific to the job. As another example, the task execution grade may be used to generate training plans. For example, the task execution grade may indicate a trainee's weaknesses at performing certain tasks, highlighting one or more areas needing improvement.

In several embodiments, the task execution grade is stored. The task execution grade may be stored for future use to assess the current user or to assess other users. For example, the task execution grade may be stored in a database as a simulation run result. Future simulation run results may be stored in the same database and compared to this simulation run result. As another example, the task execution grade may be stored in a database as benchmark data. For example, the task execution grade may be stored along with the associated detected user data. The task execution grade may be associated with a particular task and a particular simulated reality scenario. In some embodiments, the task execution grade may be associated with a gender and/or age.

FIG. 4 is a flow chart illustrating a method 250 for assessing trends in user performance over time. The method 250 is preceded by method 200 of FIG. 3, and a prior task execution grade is stored based on the user's prior performance of a task within the simulated reality environment. For example, the prior task execution grade may be a first or initial task execution grade based on the user's first or initial performance of a task. The method 250 begins with operation 252 and a simulated reality environment is presented to a user. For example, the same or similar simulated reality environment as presented in method 200 may be presented to the same user to execute the same or similar task. In some embodiments, the simulated reality environment presented to the user is identical to that presented at operation 204 of method 200. In some embodiments, the simulated reality environment presented to the user via operation 252 may vary from the simulated reality environment presented at operation 204. For example, the environment itself may vary or objects within the environment may vary. As one example, a construction task presented at operation 204 may have a set of tools presented to a user, while the same construction task presented at operation 252 may have a varying or different set of tools.

After operation 252, the method 250 may proceed with operation 254 where detected user data (e.g., second detected user data) is received and stored. As the user interacts with the simulated reality environment (e.g., performs a task within the simulated reality environment), user data is measured and detected by the system. The detected user data may be similar or the same as the user data detected at operation 206 of method 200. For example, the detected user data may include data related to biological indicators, user interactional input, and behavioral user activity, as discussed above. For example, the detected user data may include hand movement, eye movement, heart rate, blood pressure, perspiration rate, temperature, respiratory rate, breathing patterns, speech patterns, facial expressions, and the like.

After operation 254, the method 250 optionally proceeds to operation 256 where one or more task execution metrics (e.g., second task execution metrics) may be determined based on the measured user data. The one or more task execution metrics may be similar or the same as those determined at operation 208, and may include, for example, reaction time, hesitation rate and/or amount, stress levels, and the like.

After operation 254, or optionally after operation 256, the method 250 may proceed to operation 258 and the second detected user data and/or the second task execution metrics are compared to the benchmark data. The comparison may be the same as the comparison executed at operation 210. For example, as discussed above, the benchmark user data may include a single value (e.g., a threshold or average value) or a range of values. The comparison at operation 258 may assess whether the detected user data and/or task execution metrics surpass the benchmark threshold value, diverge from the benchmark average value, or fall within or outside the benchmark value range.

After operation 258, the method 250 may proceed to operation 260 where a second task execution grade is determined. The second task execution grade may be determined in the same manner as discussed above with respect to operation 212. For example, the second task execution grade is based on the benchmark task execution value or grade associated with the benchmark user data. For example, the task execution grade may be determined based on the extent the detected user data is the same as or diverges from the benchmark user data (having an associated benchmark task execution value/grade) or the extent the detected user data falls within or outside the benchmark value range.

After operation 260, the method 250 may proceed to operation 262 where the second task execution grade is compared to the task execution grade determined at operation 212 (e.g., the first task execution grade) to determine a trend. In one example, the first and second task execution grades are compared to assess improvement. For example, the second task execution grade may be higher than the first task execution grade, indicating the user improved his or her performance of the simulated task (e.g., had quicker reaction times, more steady movements, more directed/thoughtful movements, a steadier heart rate, etc.). In this example, the results may indicate the user learned from the prior simulation run and improved in the second simulation run, which may indicate that the user was applying smart guessing as opposed to prior knowledge when executing the task in the prior simulation run. As another example, the second task execution grade may be the same or similar to the first task execution grade, indicating the user's performance remained the same. In this example, the results may indicate that the user applied prior knowledge to perform the task and did not learn anything new from executing the task in the first simulation run.

As yet another example, the grades may be compared to assess the effectiveness of a training program implemented between simulation runs. For example, the first simulation run may produce a first task execution grade that indicates areas for improvement. A training program may be initiated to address the improvement areas. After a training period, the second simulation run may be executed to produce the second task execution grade. The second task execution grade may be compared to the first task execution grade to determine if the areas needing improvement improved. For example, as discussed previously, a task may include multiple sub-tasks with task execution values. Instead of comparing the overall task execution grades, the task execution grades for each sub-task can be compared between the first and second simulation runs to determine whether the performance of each sub-task improved. For example, the training program may be focused on particular sub-tasks needing performance improvement. Where the sub-tasks marked for performance improvement show improved results in the second simulation run, the training program may be deemed effective and may no longer need to be implemented. Where one or more of the sub-tasks marked for improvement do not show improved results in the second simulation run, the training program may be adjusted to target these sub-tasks for performance improvement.

In the embodiment where different simulated reality environments are presented to the user during the different simulation runs, the grades may be compared to assess the user's ability to perform the same task under different conditions. For example, a higher pressure/stress environment may be presented in the second simulation run. In one example, a lower second task execution grade than the first task execution grade may indicate an inability to perform under the higher pressure conditions. In another example, a second task execution grade that is similar to or the same as the first task execution grade may indicate a user's ability to consistently perform under varying conditions (e.g., that the user's ability to perform is unaffected by his or her environment).

After operation 262, the method 250 may proceed to operation 264 where the trend data is transmitted and/or stored. For example, the trend data may be transmitted to a user device. For example, the trend data may be transmitted to the current user who executed the task or to another user, such as, for example, an administrator. The administrator may be, for example, a trainer, an employer, a human resource employee, and the like. The trend data provides feedback to the user. The trend data may be used, for example, to assess whether to hire a candidate. For example, the trend data may indicate a candidate's ability to perform tasks specific to the job. For example, as discussed, consistent performance over multiple simulation runs may indicate prior knowledge of how to execute the task, which may be a more desirable trait for a candidate than someone who is smart guessing through a task or problem. As another example, as discussed above, the trend data may be used to generate and/or adjust a training plan. For example, the trend data may indicate a trainee's weakness or improvement in performing certain tasks, highlighting one or more areas needing improvement.

In several embodiments, the trend data is stored. The trend data may be stored for future use to assess the current user or to assess other users. For example, as additional simulation runs are performed, additional trend data may be generated according to method 250 and compared to the stored trend data to assess the user's performance improvement over time. As another example, other users may execute simulation runs of the same simulated reality scenario with the same task and trend data may be generated according to method 250. The trend data for various users may be compared to assess differences between users in performance over time and/or performance improvement overtime. In some embodiments, the trend data may be associated with a gender and/or age.

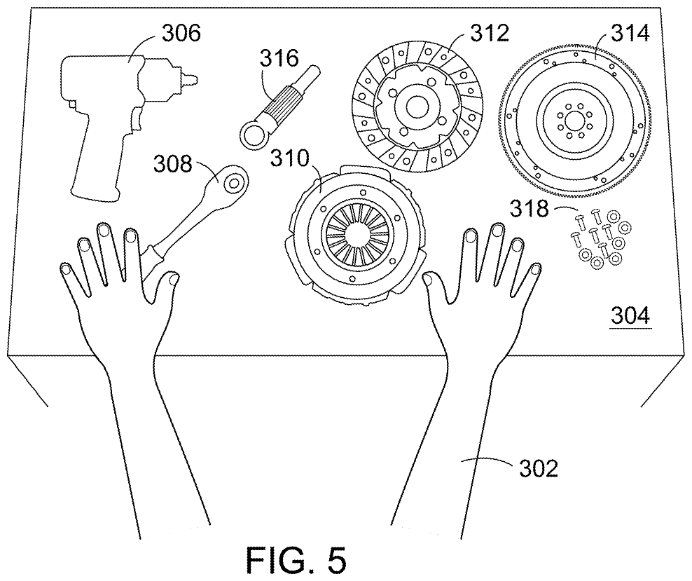

FIG. 5 is an illustration of a simulated reality scenario 300 presented by the system of FIG. 1. In the depicted example, the simulated reality scenario 300 is a workbench 304 including various tools for building a clutch. As shown, the user has an avatar 302 immersed in the virtual reality environment. The avatar 302 has simulated arms and hands that mimic the user's arm and hand movements in the real world. The avatar 302 hands can grab the tools based on the user's movements. As shown, the tools include an impact wrench 306, a torque wrench 308, a pressure plate 310, a clutch disc 312, a flywheel 314, an alignment tool 316, and a plurality of bolts and washers 318. The virtual scenario presented to the user is to assemble a clutch using the tools presented.

In this example, the user's responses and/or actions may be measured while the user either selects between tools and parts or in another example assembles a part with tools such as the clutch shown in the example. For example, the user's interactional input may be monitored. For example, the order the user reaches for the various tools, the time between grabbing each tool, the direction the user places each component, the order the user assembles the components, and the like, may be measured. For example, the system may track the user's movement relative to each tool. As shown, the system may determine that the user has reached for the torque wrench 308 and is reaching towards the flywheel 314. The system may determine the user is reaching for the flywheel 314 as opposed to the bolts and washers 318 based on the proximity and/or the angle of the user's hand relative to each component. The user may reach for the flywheel 314 seconds after reaching for the torque wrench 308, which may indicate the user is confident that the flywheel 314 and torque wrench 308 should be used together (e.g., a short timeframe between the two actions may indicate a quick decision without guessing). As another example, one or more of the user's heart rate, blood pressure, body temperature, perspiration rate, respiratory rate, breathing patterns, and the like, may be monitored. These biological indicators may be assessed in light of the action taken. For example, a spike in the user's heart rate as the user reaches for the torque wrench 308 may indicate that the user is not confident that the torque wrench 308 is the correct tool to use in assembling the clutch components. In other words, it may indicate that the user is guessing that the torque wrench 308 should be used. As another example, other behavioral activity may be monitored. For example, the user's eye movement may indicate the likelihood the user is guessing when the user grabs the torque wrench 308. For example, if the user looks back and forth between the impact wrench 306 and the torque wrench 308 before grabbing the torque wrench 308, it may indicate the user was uncertain which wrench to use and that the user was likely guessing when the user selected the torque wrench 308. As yet another example, patterns in a user's biological indicators, interactional input, and other actions may be assessed as the user executes the task (e.g., assembles the clutch), and the patterns may be analyzed as a whole to assess the overall confidence level during the simulation run and/or confidence level in particular sub-tasks.

While several of the examples described herein are discussed with reference to a confidence level or grade and/or a guessing level or grade, the examples are not so limited and may similarly be applied to any other task execution grade, such as, for example a safety grade 1406, an efficiency grade 1408, and a competency grade 1404. Additionally, other grades may include, for example, a performance level/grade, an emotional intelligence level/competency, a spatial awareness grade, a fear grade (e.g., a fear of heights), a comfort level (e.g., in a complex environment), and the like. A fear grade or comfort level may be a function of certain biological indicators, voice recognition or certain facial expressions representative of fear or comfort. The emotional intelligence level may be based on biological indicators. Spatial awareness grade may be based on detecting the user's awareness of their surroundings.

All grades are derived from metrics with assigned values representative of metric based on benchmark data of other users. The metrics may be summed, averaged, weighted, or combined to derive a grade representative of performance of a task or sub-task.

The technology described herein may be implemented as logical operations and/or modules in one or more systems. The logical operations may be implemented as a sequence of processor implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

Any and all references specifically identified in the specification of the present application are expressly incorporated herein in their entirety by reference thereto. The term “about,” as used herein, should generally be understood to refer to both the corresponding number and a range of numbers. Moreover, all numerical ranges herein should be understood to include each whole integer within the range.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A system for evaluating a user confidence grade relative to a task in a simulated reality environment, the system comprising:
a user device configured to display simulated reality to a user;
at least one sensor for monitoring detected user data associated a simulated real world task in the simulated reality environment, the user data comprising data related to at least one of biological indicators, user interactional input, and behavioral user activity;
a non-transitory memory containing computer readable instructions; and
a processor configured to process the instructions, the instructions when executed to cause the processor to:
cause display, on the user device, of the simulated reality environment configured for user interaction with the simulated real world task;
receive, from the at least one sensor, data related to the detected user data associated with the simulated real world task;
determine, based on the received detected user data, a confidence grade for the user, wherein the confidence grade is indicative of the user's confidence in performance of the simulated real world task within the simulated reality environment; and
cause transmission of feedback related to the confidence grade.

2. The system of claim 1, wherein the confidence grade is related to a probability that the user engages in guessing in performing the simulated real world task.

3. The system of claim 2, wherein:
the simulated real world task comprises one of a virtual task, a mixed reality task or an augmented reality task; and
the confidence grade is independent of the user's ability to perform the virtual, mixed or augmented reality task.

4. The system of claim 1, wherein the user interactional input includes information related to the user's physical motion used to interact with the simulated reality environment.

5. The system of claim 5, wherein the display of the simulated reality environment includes displaying instructions, on the user device, detailing the real world task requirements.

6. The system of claim 5, wherein:
the at least one sensor detects user hand motion associated with the simulated real world task in the simulated reality environment; and
the instructions when executed further cause the processor to assess the user's confidence in the placement of the hands thereby contributing to the assessment of the confidence grade.

7. The system of claim 7, wherein the confidence grade includes contribution from a user response time that is based on a determined amount of time it takes the user to engage in a predetermined correct hand motion.

8. The system of claim 1, wherein the user behavioral activity includes information related to a user's eye glance directions.

9. The system of claim 8, wherein user's eye glance directions are translated into the user's confidence in understanding the task represented in the simulated reality environment contributing to the confidence grade.

10. The system of claim 1, wherein the biological indicators are related to at least one of heart rate, breathing pattern, and blood pressure.

11. The system of claim 10, wherein the user's biological indicators are translated into the user's confidence in understanding the task represented in the simulated reality environment contributing to the confidence grade.

12. The system of claim 3, wherein the confidence grade is determined by comparing the received user detected data to benchmark data stored in a database.

13. The system of claim 12, wherein the benchmark data has an associated benchmark confidence grade.

14. The system of claim 1, wherein the instructions when executed further cause the processor to: provide an additional task, analysis, or training in the simulated reality environment in response to receiving a particular confidence grade.

15. The system of claim 1, wherein the instructions when executed further cause the processor to: store the confidence grade data for comparison to future users and establishing their confidence grade.

16. The system of claim 1, wherein the instructions when executed to cause the processor to receive further includes instructions which when executed causes the processor to receive at least two of the interactional input, the biological indicators, or the behavioral activity as the detected user data.

17. A method for evaluating a user confidence grade relative to a task in a simulated reality environment, the method comprising:
monitoring, by at least one sensor, user data associated a simulated real world task in a simulated reality environment, the user data comprising data related to at least one of biological indicators, user interactional input, and behavioral user activity; and
by a processor:
causing display, on a user device, of the simulated reality environment configured for user interaction with the simulated real world task;
receiving, from the at least one sensor, the monitored user data associated with the simulated real world task;
determining, based on the received user data, a confidence grade for the user, wherein the confidence grade is indicative of the user's confidence in performance of the simulated real world task within the simulated reality environment; and
causing transmission of feedback related to the confidence grade.

18. The method of claim 17, wherein the confidence grade is related to a probability that the user engages in guessing in performing the simulated real world task.

19. The method of claim 18, wherein:
the simulated real world task comprises one of a virtual task, a mixed reality task or an augmented reality task; and
the confidence grade is independent of the user's ability to perform the virtual, mixed or augmented reality task.

20. The method of claim 17, wherein the user interactional input includes information related to the user's physical motion used to interact with the simulated reality environment.
